(19) United States
(12) Patent Application Publication
(10) Pub. No.: US 2025/0247607 A1
(43) Pub. Date: Jul. 31, 2025

(54) CONTROL APPARATUS, CONTROL METHOD OF CONTROL APPARATUS, AND STORAGE MEDIUM

(71) Applicant: CANON KABUSHIKI KAISHA, Tokyo (JP)

(72) Inventors: SEIGO KANEKO, Kanagawa (JP); KENTARO FUKUNAGA, Kanagawa (JP)

(21) Appl. No.: 19/038,455

(22) Filed: Jan. 27, 2025

(30) Foreign Application Priority Data
Jan. 29, 2024 (JP) 2024-011067

(51) Int. Cl. H04N 23/63; H04N 23/62; H04N 23/695; H04N 23/90

(52) U.S. Cl. CPC H04N 23/632; H04N 23/62; H04N 23/695; H04N 23/90

(57) ABSTRACT

A control apparatus includes one or more memories storing instructions, and one or more processors executing the instructions to acquire a detection result of an object detected from images acquired by a plurality of respective imaging units configured to move independently on the same circumference, and in a case where the object is determined to be detected based on the detection result, control to display a first graphical user interface on a display unit, the first graphical user interface being configured to change an imaging region of an imaging unit acquiring an image where the object is detected among the plurality of imaging units.

### BACKGROUND

### Field of the Disclosure

The present disclosure relates to a control apparatus, a control method of the control apparatus, and a storage medium.

### Description of the Related Art

To enable imaging in a plurality of directions with a single camera, there is a camera that includes a plurality of imaging units (hereinafter, multi-lens camera). Among multi-lens cameras is an imaging apparatus including a driving mechanism capable of independently driving imaging units on a common driving axis, like along the same circumference. In such an imaging apparatus, the user can independently operate the imaging positions of the respective imaging units from a personal computer (PC) connected via a network. Each time the user operates the imaging position of an imaging unit, the user therefore desirably selects the imaging unit to operate.

Japanese Patent Application Laid-Open No. 2021-136537 discusses a technique for disabling (fixing) the operation of a driving unit that the user does not wish to operate in a multi-lens camera.

However, while the technique discussed in Japanese Patent Application Laid-Open No. 2021-136537 can prevent unintended operations by fixing the driving units, the user ends up unfixing the driving unit to move each time. When an object of interest enters an image being captured and the user wishes to operate the driving unit, the user is therefore unable to immediately operate the driving unit.

Even if all the imaging units are not fixed, the imaging unit to be operated is desirably selected aside from the disabling setting. This complicates the operations since the user selects the imaging unit detecting the object and deselects the other imaging unit.

### SUMMARY

The present disclosure is directed to facilitating changing the imaging region of an imaging unit when an object is detected.

According to an aspect of the present disclosure, a control apparatus includes one or more memories storing instructions, and one or more processors executing the instructions to acquire a detection result of an object detected from images acquired by a plurality of respective imaging units configured to move independently on the same circumference, and in a case where the object is determined to be detected based on the detection result, control to display a first graphical user interface on a display unit, the first graphical user interface being configured to change an imaging region of an imaging unit acquiring an image where the object is detected among the plurality of imaging units.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an imaging system.

FIG. 2 is a diagram illustrating an imaging apparatus.

FIG. 3 is a side view of the imaging apparatus.

FIG. 4 is a diagram illustrating a configuration example of the imaging system.

FIG. 5 is a diagram illustrating a configuration example of the imaging system.

FIG. 6 is a flowchart during object detection.

FIGS. 7A and 7B are diagrams illustrating a display example in a browsing mode.

FIGS. 8A and 8B are diagrams illustrating an example of a graphical user interface (GUI) for transitioning to a priority drive mode.

FIGS. 9A and 9B are diagrams illustrating a display example in the priority drive mode.

FIGS. 10A and 10B are diagrams illustrating an example of slider bars.

FIGS. 11A and 11B are diagrams illustrating an example where imaging units other than an object-detecting camera are withdrawn.

FIGS. 12A and 12B are diagrams illustrating an example where the imaging units other than the object-detecting camera are withdrawn.

FIGS. 13A and 13B are diagrams illustrating a control example of the imaging units other than the object-detecting camera.

FIGS. 14A and 14B are diagrams illustrating a display example for switching selection of an imaging unit.

FIGS. 15A and 15B are diagrams illustrating a display example after the switching of selection of an imaging unit.

FIG. 16 is a flowchart during object detection.

FIG. 17 is a diagram illustrating an example of a GUI related to transition methods.

FIG. 18A and 18B are flowcharts during object detection.

### DESCRIPTION OF THE EMBODIMENTS

Exemplary embodiments of the present disclosure will be described in detail below with reference to the drawings. The following exemplary embodiments are not intended to limit the scope of the claims. While the exemplary embodiments describe a plurality of features, all the plurality of features is not necessarily essential, and the features may be freely combined. In the diagrams, the same or similar components are denoted by the same reference numerals. A redundant description thereof will be omitted.

### Imaging System

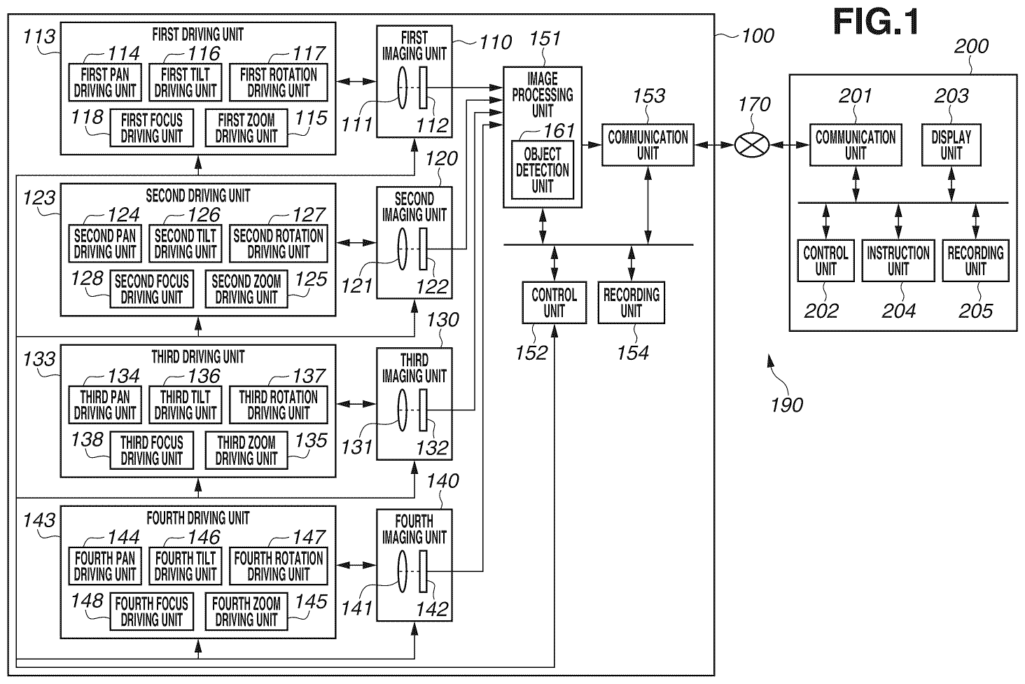

A configuration of an imaging system 190 according to a first exemplary embodiment will be described below with reference to FIG. 1. FIG. 1 is a diagram illustrating a configuration example of the imaging system 190 according to the first exemplary embodiment. The imaging system 190 includes an imaging apparatus 100 and a client apparatus 200.

The imaging apparatus 100 includes four imaging units 110, 120, 130, and 140, independent driving units 113, 123, 133, and 143 for the respective imaging units 110, 120, 130, and 140, an image processing unit 151, a control unit 152, a communication unit 153, and a recording unit 154.

Specifically, the imaging apparatus 100 includes a first imaging unit 110, a second imaging unit 120, a third imaging unit 130, and a fourth imaging unit 140. The imaging apparatus 100 also includes a first driving unit 113, a second driving unit 123, a third driving unit 133, and a fourth driving unit 143.

In the imaging system 190, the imaging apparatus 100 is connected to the client apparatus 200 via a network 170, and can transmit image data captured by the imaging apparatus 100 and receive control signals for the imaging apparatus 100.

### Imaging Units

The first imaging unit 110 includes an imaging optical system 111 and a solid-state image sensor 112. The second imaging unit 120 includes an imaging optical system 121 and a solid-state image sensor 122. The third imaging unit 130 includes an imaging optical system 131 and a solid-state image sensor 132. The fourth imaging unit 140 includes an imaging optical system 141 and a solid-state image sensor 142.

Light transmitted through the imaging optical systems 111, 121, 131, and 141 is focused on the solid-state image sensors 112, 122, 132, and 142, respectively, and converted into electrical signals. The electrical signals are output as image data through processing by the image processing unit 151. The control unit 152 controls the driving and signal reading of each of the solid-state image sensors 112, 122, 132, and 142.

The first driving unit 113 includes a first pan driving unit 114, a first zoom driving unit 115, a first tilt driving unit 116, a first rotation driving unit 117, and a first focus driving unit 118.

The second driving unit 123 includes a second pan driving unit 124, a second zoom driving unit 125, a second tilt driving unit 126, a second rotation driving unit 127, and a second focus driving unit 128.

The third driving unit 133 includes a third pan driving unit 134, a third zoom driving unit 135, a third tilt driving unit 136, a third rotation driving unit 137, and a third focus driving unit 138.

The fourth driving unit 143 includes a fourth pan driving unit 144, a fourth zoom driving unit 145, a fourth tilt driving unit 146, a fourth rotation driving unit 147, and a fourth focus driving unit 148.

The imaging units 110, 120, 130, and 140 include respective zoom lenses that the imaging optical systems 111, 121, 131, and 141 can drive in their optical axis directions. The control unit 152 can control the imaging ranges of the imaging units 110, 120, 130, and 140 by controlling the first, second, third, and fourth zoom driving units 115, 125, 135, and 145.

The imaging units 110, 120, 130, and 140 include respective focus lenses that the imaging optical systems 111, 121, 131, and 141 can drive in their optical axis directions. The control unit 152 can control the focuses of the imaging units 110, 120, 130, and 140 by controlling the first, second, third, and fourth focus driving units 118, 128, 138, and 148.

The driving units 113, 123, 133, and 143 include the rotation driving units 117, 127, 137, and 147, respectively, that can drive the solid-state image sensors 112, 122, 132, and 142 to rotate about rotation axes in the respective optical axis directions. The control unit 152 can control the imaging angles of the imaging units 110, 120, 130, and 140 by controlling the first, second, third, and fourth rotation driving units 117, 127, 137, and 147.

### Pan/Tilt Driving Units

The driving units 113, 123, 133, and 143 include the pan driving units 114, 124, 134, and 144, and the tilt driving units 116, 126, 136, and 146. The pan driving units 114, 124, 134, and 144, and the tilt driving units 116, 126, 136, and 146 are driving units for changing imaging regions.

The first, second, third, and fourth driving units 113, 123, 133, and 143 include the first, second, third, and fourth pan driving units 114, 124, 134, and 144, respectively. Similarly, the first, second, third, and fourth driving units 113, 123, 133, and 143 include the first, second, third, and fourth tilt driving units 116, 126, 136, and 146, respectively.

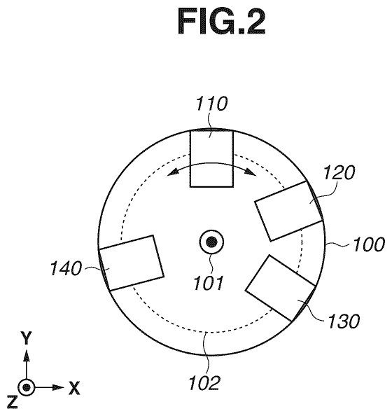

The first, second, third, and fourth pan driving units 114, 124, 134, and 144 are configured to have the same rotation axis so that the imaging units 110, 120, 130, and 140 are located on the same circumference and rotate on the same circumference. A specific description will be given with reference to FIG. 2.

FIG. 2 is a diagram illustrating the imaging apparatus 100 according to the first exemplary embodiment. To simplify the following description, content that is redundant between the imaging units (first, second, third, and fourth imaging units 110, 120, 130, and 140) will be described by using the first imaging unit 110 in a representative manner, and a description of the other imaging units will be omitted. Similarly, for the driving units 113, 123, 133, and 143, the first driving unit 113 will be described in a representative manner, and a description of the other driving units will be omitted. Differences between the imaging units will be explicitly stated, if any.

FIG. 2 is a structure diagram of the imaging apparatus 100 seen from above (from a +Z-axis side). The pan driving units 114, 124, 134, and 144 include a motor and a gear each, and drive the respective imaging units 110, 120, 130, and 140 by controlling power to drive the motors.

The pan driving units 114, 124, 134, and 144 are configured to be rotatable with a shaft 101 as the rotation axis. A circumference 102 represents the common circumference along which the imaging units 110, 120, 130, and 140 can be driven with the shaft 101 as the rotation axis. The power to drive the motors is controlled by the control unit 152.

The imaging apparatus 100 can independently drive the imaging units 110, 120, 130, and 140, and can independently drive one or more of the pan driving units 114, 124, 134, and 144 at the same time. Since all the imaging units 110, 120, 130, and 140 are driven on the same circumference 102, the imaging units 110, 120, 130, and 140 do not switch positions. The plurality of imaging units 110, 120, 130, and 140 is located on the same circumference 102 and can independently change their pan angles on the same circumference 102.

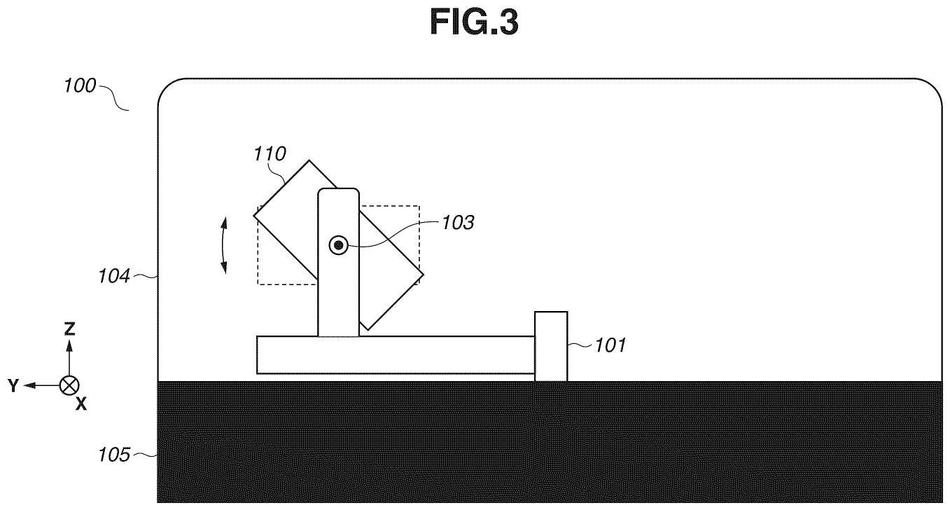

The tilt driving units 116, 126, 136, and 146 will be described with reference to FIG. 3. FIG. 3 is a diagram illustrating the imaging apparatus 100 according to the first exemplary embodiment as seen from a side (-X-axis side). The tilt driving units 116, 126, 136, and 146 include a motor and a gear each, and drive the respective imaging units 110, 120, 130, and 140 by controlling power to drive the motors.

The tilt driving unit 116 is configured to be rotatable with a shaft 103 as the rotation axis. The power to drive the motor is controlled by the control unit 152. The imaging apparatus 100 can independently drive the imaging units 110, 120, 130, and 140, and can independently drive one or more of the tilt driving units 116, 126, 136, and 146 at the same time.

A dome 104 is formed of a transparent member such as plastic and glass, and the imaging unit 110 can capture images of the surroundings outside the imaging apparatus 100. A fixing unit 105 is a fixing member to be attached to a ceiling, floor, or wall.

Unlike the pan driving units 114, 124, 134, and 144, the tilt driving units 116, 126, 136, and 146 do not cause physical interference between the imaging units 110, 120, 130, and 140. Similarly, the zoom driving units 115, 125, 135, and 145, the focus driving units 118, 128, 138, and 148, and the rotation driving units 117, 127, 137, and 147 do not cause physical interference between the imaging units 110, 120, 130, and 140.

### Zoom Driving Units/Focus Driving Units

The zoom driving units 115, 125, 135, and 145 include a motor and a gear each, and can drive the zoom lenses included in the respective imaging optical systems 111, 121, 131, and 141 by controlling power to drive the motors. The zoom driving units 115, 125, 135, and 145 further include configurations capable of acquiring the positions of the zoom lenses using photointerrupters or Hall elements.

The angles of view (zoom magnifications) of the imaging units 110, 120, 130, and 140 can be changed by driving the zoom driving units 115, 125, 135, and 145. The power to drive the motors is controlled by the control unit 152. The imaging apparatus 100 can independently drive the imaging units 110, 120, 130, and 140, and can independently drive one or more of the zoom driving units 115, 125, 135, and 145 at the same time.

The focus driving units 118, 128, 138, and 148 include a motor and a gear each, and can drive the focus lenses included in the respective imaging optical system 111, 121, 131, and 141 by controlling power to drive the motors. The focus driving units 118, 128, 138, and 148 further include configurations capable of acquiring the positions of the focus lenses using photointerrupters or Hall elements. The focus positions (in-focus positions) of the imaging units 110, 120, 130, and 140 can be changed by driving the focus driving units 118, 128, 138, and 148. The power to drive the motors is controlled by the control unit 152. The imaging apparatus 100 can independently drive the imaging units 110, 120, 130, and 140, and can independently drive one or more of the focus driving units 118, 128, 138, and 148 at the same time.

### Rotation Driving Units

The rotation driving units 117, 127, 137, and 147 include a motor and a gear each, and can independently control the imaging units 110, 120, 130, and 140 by controlling power to drive the motors. Imaging regions having landscape aspect ratios can be changed into portrait aspect ratios by rotating the rotation driving units 117, 127, 137, and 147 by 90° with their optical axis directions as the axes. The rotation driving units 117, 127, 137, and 147 can be rotated within the range of 0° to 360°, not necessarily 90°. With 0° as the reference, the state of being at 0° is referred to as having a landscape aspect ratio.

### Communication Unit

The communication unit 153 transfers the images transmitted from the image processing unit 151 to the client apparatus 200 via the network 170 that is a wired or wireless network. The communication unit 153 accepts instructions from the client apparatus 200.

### Control Unit

The control unit 152 includes a central processing unit (CPU) that controls the imaging units 110, 120, 130, and 140, the driving units 113, 123, 133, and 143, the image processing unit 151, and the communication unit 153 as described above. The control unit 152 controls the imaging apparatus 100 in a comprehensive manner.

### Recording Unit

The recording unit 154 includes a random access memory (RAM) and a read- only memory (ROM). The recording unit 154 temporarily stores computer programs, and stores programs for the control unit 152 to control the imaging apparatus 100.

### Client Apparatus

The client apparatus 200 includes a communication unit 201, a control unit 202, a display unit 203, an instruction unit 204, and a recording unit 205.

The communication unit 201 of the client apparatus 200 can communicate with the imaging apparatus 100 via the network 170.

The display unit 203 is a display device such as a display monitor, and can display a display image transmitted from the imaging apparatus 100.

The instruction unit 204 includes a user interface. The instruction unit 204 accepts mouse (pointing device) and keyboard operations made by the user, and generates control signals for the control unit 202 to control the imaging apparatus 100. Examples of the control signals include ones for controlling the driving units 113, 123, 133, and 143.

In other words, the user can control the pan/tilt driving units and the zoom magnifications of the imaging units 110, 120, 130, and 140 from the client apparatus 200 via the network 170. The user can also control the imaging apparatus 100 as described above by operating a graphical user interface (GUI) in the display image using a mouse. While the mouse is mentioned as an example, other means such as touchscreen operations may be used.

Examples of the client apparatus 200 include devices such as a personal computer. The network 170 includes a wired local area network (LAN) and/or a wireless LAN. The client apparatus 200 may be configured to supply power to the imaging apparatus 100 via the network 170.

The control unit 202 includes CPU functions, and controls the client apparatus 200 in a comprehensive manner. The recording unit 205 includes a RAM and a ROM. The recording unit 205 temporarily stores computer programs, and stores programs for the control unit 202 to control the client apparatus 200.

### Image Processing Unit

The image processing unit 151 performs development processing (operations) on captured data (captured images) captured by the imaging units 110, 120, 130, and 140 based on a display format. For example, if there are four imaging units 110, 120, 130, and 140, and four images are to be simultaneously displayed, the image processing unit 151 tiles the pieces of image data in two rows and two columns and develops the pieces of image data into a single display image.

The image processing unit 151 includes an object detection unit 161. The object detection unit 161 analyzes the acquired captured images by image processing. For example, in the case of detecting a moving object as an object, the object detection unit 161 calculates differences in luminance between the frames of the captured images. If there is a change in luminance, the object detection unit 161 determines that a moving object is detected. The user can instruct what to detect as an object via the instruction unit 204.

The image processing unit 151 can display (superimpose) a GUI on the captured data as an on-screen display (OSD). The superimposed OSD is a GUI the user can operate.

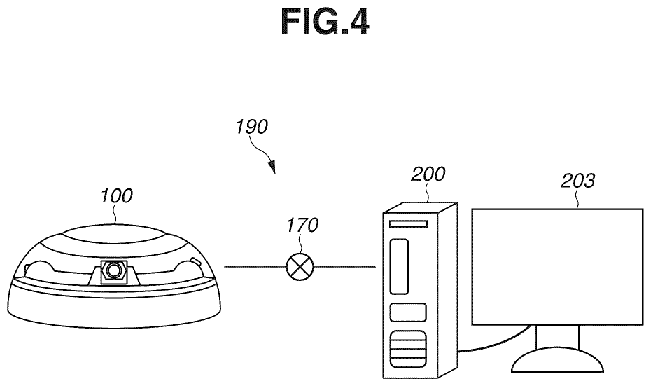

A configuration example of the imaging system 190 will be described with reference to FIG. 4. FIG. 4 is a diagram illustrating the configuration example of the imaging system 190 according to the first exemplary embodiment. The imaging system 190 includes the imaging apparatus 100, the network 170, the client apparatus 200, and the display unit 203.

The imaging apparatus 100 is connected to the client apparatus 200 via the network 170. While FIG. 4 illustrates a desktop personal computer as an example of the client apparatus 200, a laptop personal computer or a tablet where the client apparatus 200 and the display unit 203 are integrated may be used.

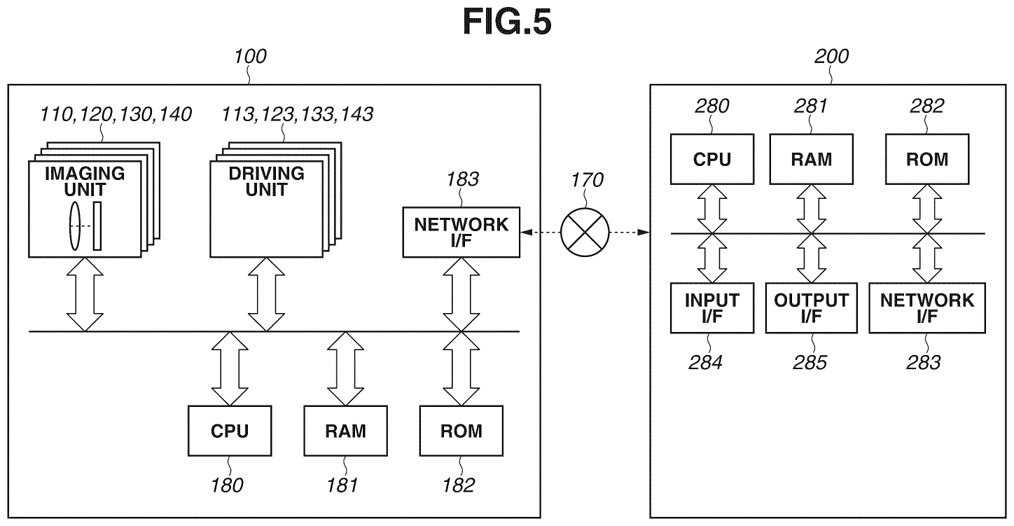

Details of the configuration of the imaging apparatus 100 and the client apparatus 200 will be described with reference to FIG. 5. FIG. 5 is a diagram illustrating a detailed configuration example of the imaging apparatus 100 and the client apparatus 200 according to the first exemplary embodiment.

The imaging apparatus 100 includes the imaging units 110, 120, 130, and 140, the driving units 113, 123, 133, and 143, a network interface (I/F) 183, a CPU 180, a RAM 181, and a ROM 182.

The CPU 180 is a CPU that controls the imaging apparatus 100 in a comprehensive manner. The CPU 180 controls the control unit 152, the image processing unit 151, and the communication unit 153 of FIG. 1.

The RAM 181 temporarily stores computer program for the CPU 180 to execute. The RAM 181 also provides a work area that the CPU 180 uses when performing processing. The RAM 181 also functions as a frame memory and a buffer memory.

The ROM 182 stores programs for the CPU 180 to control the imaging apparatus 100.

The network I/F 183 transmits the developed display image to the client apparatus 200 via the network 170. The image data captured by the imaging units 110, 120, 130, and 140 may be stored in an internal storage device such as the RAM 181 and the ROM 182 to be described below, or a not-illustrated removable storage medium such as a memory card.

The client apparatus 200 is an information processing apparatus including a CPU 280, a RAM 281, a ROM 282, an input I/F 284, an output I/F 285, and a network I/F 283.

The CPU 280 is a CPU that controls the client apparatus 200 in a comprehensive manner.

The RAM 281 provides a work area that the CPU 280 uses when performing data processing. The RAM 281 also functions as a frame memory and a buffer memory.

The ROM 282 stores programs for the CPU 280 to control the client apparatus 200.

The input I/F 284 is an I/F for connecting to the instruction unit 204 of FIG. 1 and accepting operations on the client apparatus 200, input by the user via the instruction unit 204. The input I/F 284 can also accept operation information for the imaging apparatus 100.

The output I/F 285 is an I/F for connecting to the display unit 203 of FIG. 4 and displaying the display image output from the imaging apparatus 100 on the display unit 203.

The network I/F 283 is an I/F for connecting to the imaging apparatus 100 via the network 170 and inputting the operation information for the imaging apparatus 100, input through the input I/F 284, to the imaging apparatus 100. The network I/F 283 also accepts the display image output from the imaging apparatus 100.

### Flowchart

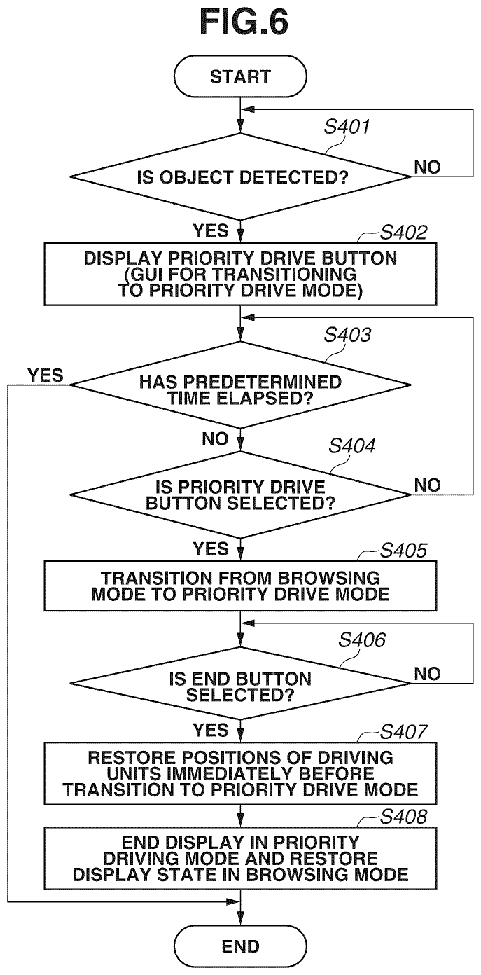

An operation of the imaging apparatus 100 during object detection will now be described with reference to FIG. 6. FIG. 6 is a flowchart illustrating a control method of the imaging apparatus 100 according to the first exemplary embodiment, specifically during object detection. This flowchart is implemented by the CPU 180 of the imaging apparatus 100 executing a program loaded into the RAM 181. Here, the imaging apparatus 100 is an example of a control apparatus. The plurality of imaging units 110, 120, 130, and 140 is built in the imaging apparatus 100.

The imaging regions of the plurality of imaging units 110, 120,130, and 140 can be independently changed using the pan driving units 114, 124, 134, and 144, the tilt driving units 116, 126, 136, and 146, the zoom driving units 115, 125, 135, and 145, and the rotation driving units 117, 127, 137, and 147. Each imaging region has at least one of a pan angle, tilt angle, zoom magnification, and rotation angle. The plurality of imaging units 110, 120, 130, and 140 can be independently moved on the same circumference 102 by the pan driving units 114, 124, 134, and 144.

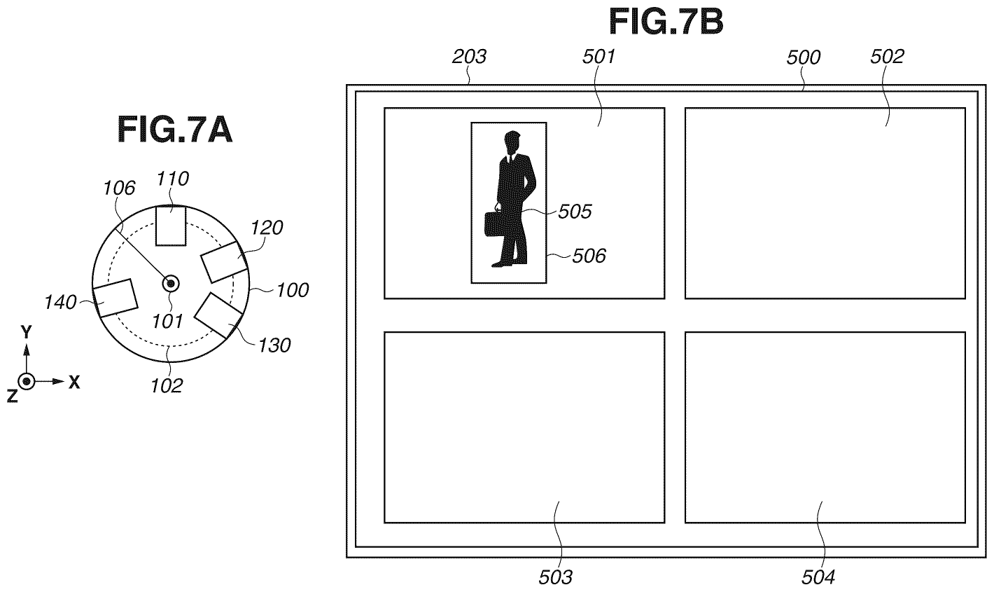

In step S401, the object detection unit 161, from images captured by the plurality of imaging units 110, 120, 130, and 140, determine whether the object is detected. For example, as illustrated in FIG. 7B, the object detection unit 161 detects a moving body 505 in an image 501 captured by the imaging unit 110 as an object. If no object is detected (NO in step S401), the processing returns to step S401. The CPU 180 thereby enters a standby state. If an object is detected (YES in step S401), the processing proceeds to step S402. An imaging unit capturing an image where an object is detected will be referred to as an object-detecting camera.

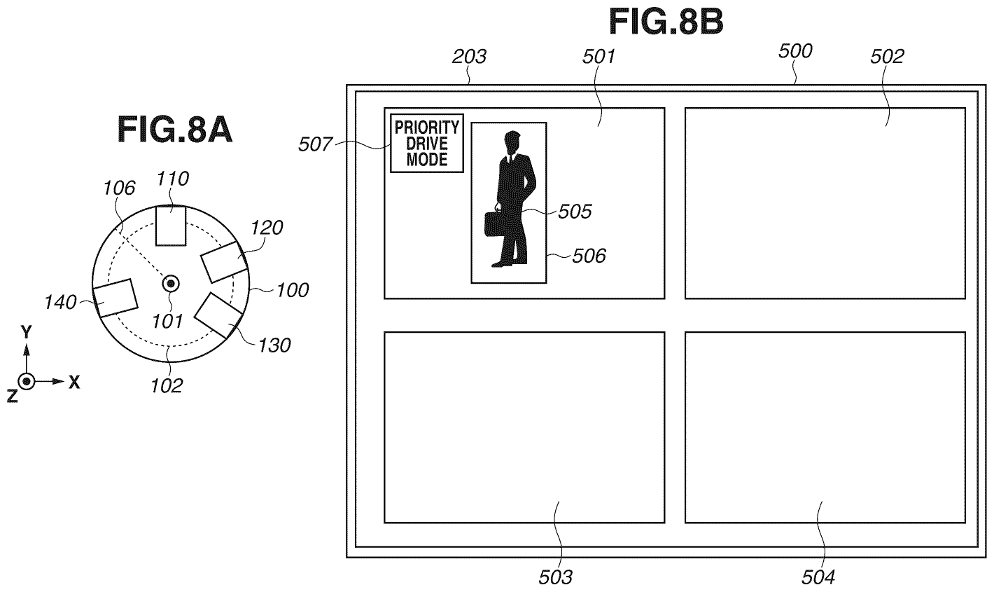

In step S402, the CPU 180 controls to display images 501 to 504 in a browsing mode on the display unit 203 as illustrated in FIG. 8B. The image 501 is an image captured by the imaging unit 110. The image 502 is an image captured by the imaging unit 120. The image 503 is an image captured by the imaging unit 130. The image 504 is an image captured by the imaging unit 140.

The CPU 180 also controls to display a frame 506 of the moving body 505 detected in the image 501 on the display unit 203.

The CPU 180 further controls to display on the display unit 203 a priority drive button 507 on the object-detected image 501 in a superposed manner as illustrated in FIG. 8B. The priority drive button 507 is a graphical user interface (GUI) for selecting whether to transition to a priority drive mode. The priority drive button 507 also serves as a GUI for switching display.

In step S403, the CPU 180 determines whether a predetermined time has elapsed since the processing of step S402. If the predetermined time has not elapsed (NO in step S403), the processing proceeds to step S404. If the predetermined time has elapsed (YES in step S403), the processing of the flowchart of FIG. 6 ends.

In step S404, the CPU 180 determines whether the priority drive button 507 is selected (clicked, tapped, or otherwise operated) by the user. If the priority drive button 507 is selected (YES in step S404), the processing proceeds to step S405. If the priority drive button 507 is not selected (NO in step S404), the processing returns to step S403.

In step S405, the CPU 180 transitions from the browsing mode to the priority drive mode.

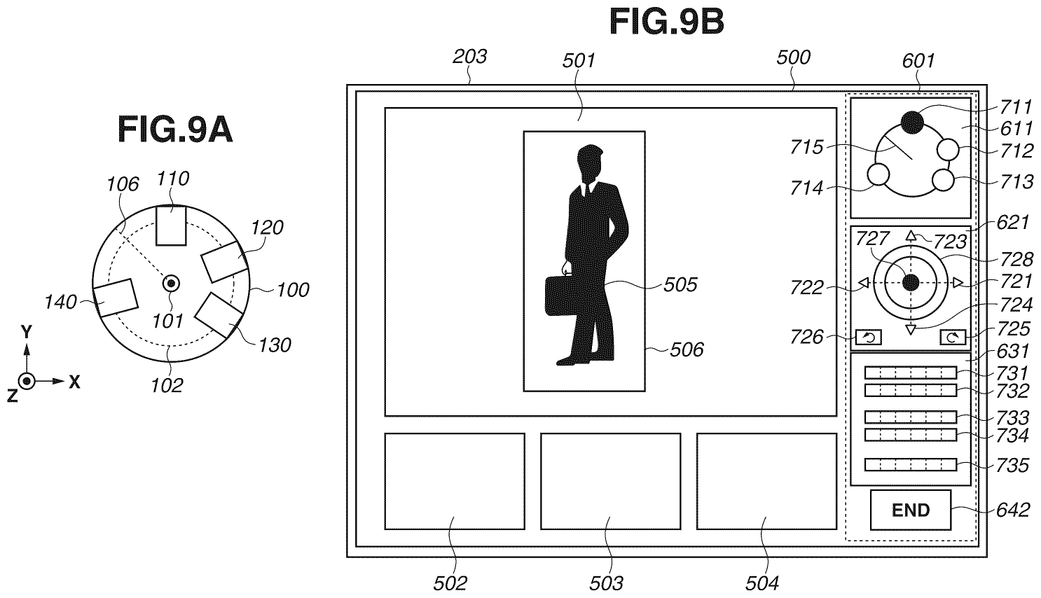

The CPU 180 then functions as a control unit and controls to display on the display unit 203 a GUI operation area 601 for changing the imaging region of the imaging unit 110 that is the object-detecting camera among the plurality of imaging units 110, 120, 130, and 140 as illustrated in FIG. 9B. The operation area 601 includes an imaging unit selection panel 611, an operation panel 621, an operation panel 631, and an end button 642.

The CPU 180 also controls to display on the display unit 203 the images 501 to 504 captured by the plurality of imaging units 110, 120, 130, and 140 as illustrated in FIG. 9B.

The CPU 180 records the positions of the driving units of the object-detecting camera immediately before the transition to the priority drive mode in the recording unit 154 or 205. GUIs capable of changing the imaging region of the object-detecting camera are displayed with the imaging region of only the object-detecting camera changeable.

The CPU 180 instructs the driving unit 113 to change the imaging region of the imaging unit 110 capturing the object-detected image 501 based on operations on the operation panel 621 or 631 of FIG. 9B.

In step S406, the CPU 180 determines whether the end button 642 of FIG. 9B is selected. If the end button 642 is selected (YES in step S406), the processing proceeds to step S407 to cancel the priority drive mode. If the end button 642 is not selected (NO in step S406), the processing returns to step S406. The user can operate the object-detecting camera from the GUIs in the priority drive mode of FIG. 9B until the end button 642 is selected.

The processing may proceed from step S406 to step S407 after a lapse of a predetermined time since the processing of step S405 without the end button 642 being selected in step S406.

In step S407, the CPU 180 reads the positions of the driving units of the object-detecting camera immediately before the transition to the priority drive mode from the recording unit 154 or 205. The CPU 180 then drives the driving units of the object-detecting camera to the read positions of the driving units, whereby the positions of the driving units immediately before the transition to the priority drive mode are restored.

In FIG. 9B, the CPU 180 may change the imaging region of the imaging unit selected by the user among the plurality of imaging units. In such a case, if the end button 642 is selected (YES in step S406), then in step S407, the CPU 180 issues instructions to restore the imaging regions of all the plurality of imaging units to those immediately before the display of the operation area 601.

In step S408, the CPU 180 controls the display on the display unit 203 to end the display in the priority drive mode of FIG. 9B and restore the display state in the browsing mode of FIG. 8B.

A display method in the browsing mode will be described with reference to FIGS. 7A and 7B. FIG. 7A and 7B are diagrams illustrating a display example in the browsing mode according to the first exemplary embodiment.

FIG. 7A is a diagram illustrating a structure example similar to that of FIG. 2, illustrating the positional relationship between the imaging units 110, 120, 130, and 140. FIG. 7A illustrates a case where there is a driving end 106 of the pan driving units. The driving end 106 of the pan driving units will be described below.

FIG. 7B illustrates how the images 501, 502, 503, and 504 of the imaging units 110, 120, 130, and 140 are displayed on the display unit 203 of the client apparatus 200.

In the browsing mode, for the sake of simultaneous browsing of the plurality of images 501 to 504, only the images 501 to 504 are displayed without displaying operation-specific GUIs for driving the driving units. In the browsing mode, compared to the priority drive mode of FIG. 9B to be described below, the operation-specific GUIs are desirably hidden or displayed in small sizes so that the four images 501 to 504 are displayed accordingly larger.

The display image 500 of FIG. 7B is the display image developed by the image processing unit 151 and is displayed on the display screen of the display unit 203. The image 501 is the image captured by the imaging unit 110. The image 502 is the image captured by the imaging unit 120. The image 503 is the image captured by the imaging unit 130. The image 504 is the image captured by the imaging unit 140.

FIG. 7B illustrates an example where an object is detected in the image 501 of the imaging unit 110. When an object is captured within the angle of view of the imaging unit 110 and the object moves to cause luminance differences between frames, the object detection unit 161 detects the object as the moving body 505. When the moving body 505 is detected, the detection result is displayed in the image 501 in an easy-to-understand manner. As the display result, the frame 506 of the moving body 505 is displayed on the image 501 in the form of an OSD.

The priority drive button 507 will be described with reference to FIGS. 8A and 8B. FIGS. 8A and 8B are diagrams illustrating an example of a GUI in the browsing mode according to the first exemplary embodiment.

FIG. 8A is a diagram illustrating a structure example similar to that of FIG. 7A, illustrating the positional relationship between the imaging units 110, 120, 130, and 140.

FIG. 8B illustrates an example where the priority drive button 507 is displayed on the object-detected image 501 as an OSD. When the user views the image 501 captured by the imaging unit 110 and wishes to drive the imaging unit 110, the user selects the priority drive button 507. FIG. 9B illustrates a display example in the priority drive mode when the priority drive button 507 is selected.

The display example in the priority drive mode will be described with reference to FIGS. 9A and 9B. FIGS. 9A and 9B are diagrams illustrating the display example in the priority drive mode according to the first exemplary embodiment.

FIG. 9A is a diagram illustrating a structure example similar to that of FIG. 7A, illustrating the positional relationship between the imaging units 110, 120, 130, and 140.

FIG. 9B illustrates an example where the images 501 to 504 output from the imaging apparatus 100 are displayed on the display unit 203. In FIG. 9B, in transitioning to the priority drive mode, GUIs for operating the driving unit 113 are displayed in a state where only the imaging unit 110 that is the object-detecting camera is selected.

The state where only the object-detecting camera is selected refers to a state in which only the object-detecting camera can be driven. In transitioning to the priority drive mode, operation-specific GUIs are displayed. The driving end 106 and a driving end 715 of the pan driving units will be described below.

The operation area 601 is an area for displaying not the captured images but GUIs that are images for the user to operate the imaging unit 110. The operation area 601 includes the imaging unit selection panel 611, the operation panels 621 and 631, and the end button 642.

The imaging unit selection panel 611 is a GUI indicating the driving unit of which imaging unit can be operated (is selected). An imaging unit selection button 711 corresponds to the imaging unit 110. An imaging unit selection button 712 corresponds to the imaging unit 120. An imaging unit selection button 713 corresponds to the imaging unit 130. An imaging unit selection button 714 corresponds to the imaging unit 140.

In FIG. 9B, since the imaging unit 110 is the object-detecting camera, the imaging unit selection panel 611 is displayed with only the imaging unit selection button 711 selected in transitioning to the priority drive mode. The imaging unit selection panel 611 is desirably displayed the positional relationship of the imaging units 110, 120, 130, and 140 illustrated in FIG. 9A in an easy-to-understand manner.

If the pan driving unit 114 of the imaging unit 110 is driven, the position of the imaging unit selection button 711 also moves to match the position of the imaging unit 110. Displaying the GUI indicating the positional relationship with driving units to interfere enables the user to recognize the driving range.

The operation panel 621 is a GUI for operating the pan driving unit 114, the tilt driving unit 116, and the rotation driving unit 117. The imaging unit 110 selected on the imaging unit selection panel 611 can thereby be operated.

A pan button 721 and a pan button 722 are buttons for operating the pan driving unit 114. The pan button 721 is a button for rotating the imaging unit 110 clockwise about the shaft 101. The pan button 722 is a button for rotating the imaging unit 110 counterclockwise about the shaft 101.

A tilt button 723 and a tilt button 724 are buttons for operating the tilt driving unit 116. The tilt button 723 is a button for rotating the imaging unit 110 upward about the shaft 103 of FIG. 3. The tilt button 724 is a button for rotating the imaging unit 110 downward about the shaft 103 of FIG. 3.

A rotation button 725 and a rotation button 726 are buttons for operating the rotation driving unit 117. The rotation button 725 is a button for rotating the solid-state image sensor 112 of the imaging unit 110 clockwise about the optical axis. The rotation button 726 is a button for rotating the solid-state image sensor 112 of the imaging unit 110 counterclockwise about the optical axis.

The driving unit 113 operates while these buttons are pressed. The shorter the pressing time, the smaller the driving amount. The longer the pressing time, the greater the driving amount. The user can thus freely operate the driving directions and amounts.

A driving state button 727 is a button indicating the driving state. When the driving unit 113 is not being driven, the driving state button 727 is displayed at a reference position (center) of a frame 728. When the driving unit 113 is being driven, the position of the driving state button 727 moves.

When the pan driving unit 114 is driven, the driving state button 727 moves laterally.

When the tilt driving unit 116 is driven, the driving state button 727 moves vertically.

When both the pan and tilt driving units 114 and 116 are driven, the driving state button 727 moves obliquely.

The moving direction of the driving state button 727 corresponds to that of each driving unit.

For example, if the pan button 721 is selected, the driving state button 727 moves to the right. The moving amount of the driving state button 727 may be changed depending on the driving speed. The lower the driving speed, the closer the driving state button 727 is located to the reference position.

The driving state button 727 may be an operable GUI. The driving unit 113 can be driven in any direction by the user dragging the driving state button 727.

Like the operation panel 621, the operation panel 631 is a GUI for operating the driving unit 113 of the imaging apparatus 100. The pan driving unit 114, the tilt driving unit 116, the rotation driving unit 117, the zoom driving unit 115, and the focus driving unit 118 can be operated using the operation panel 631.

The operation panel 631 includes pan buttons 731, tilt buttons 732, zoom buttons 733, focus buttons 734, and rotation buttons 735. The numbers of operation buttons 731 to 735 are six each. The six buttons can drive the driving unit 113 by specifying respective different driving amounts.

For example, the pan buttons 731 display discrete relative values of driving angle) (°), like −30, −20, −10, 10, 20, and 30 from the left (not illustrated). If, for example, the user clicks the rightmost button labeled 30, the imaging unit 110 is driven by 30° clockwise (in the same direction as with the pan button 721).

The tilt buttons 732 can also be operated like the pan buttons 731. For example, the tilt buttons 732 display discrete relative values of driving angle) (°), like −30, −20, −10, 10, 20, and 30 from the left (not illustrated). If, for example, the user clicks the rightmost button labeled 30, the imaging unit 110 is driven by 30° upward (in the same direction as with the tilt button 723).

The zoom buttons 733 can also be operated like the pan buttons 731. For example, the zoom buttons 733 display discrete relative values of driving angle, like −30, −20, −10, 10, 20, and 30 from the left (not illustrated). If, for example, the user clicks the rightmost button labeled 30, the zoom driving unit 115 is driven to the far side by 30. The numerical values here are dimensionless values in proportion to the motor rotation angle with the wide-angle end as 0 and the telephoto end as 100.

The focus buttons 734 can also be operated like the pan buttons 731. For example, the focus buttons 734 display discrete relative values of driving angle, like −30, −20, −10, 10, 20, and 30 from the left (not illustrated). If, for example, the user clicks the rightmost button labeled 30, the focus driving unit 118 is driven to the telephoto side by 30. The numerical values here are dimensionless values in proportion to the motor rotation angle with the near end as 0 and the far end as 100.

The rotation buttons 735 can also be operated like the pan buttons 731.

For example, the rotation buttons 735 display discrete relative values of driving angle (°), like −30, −20, −10, 10, 20, and 30 from the left (not illustrated). If, for example, the user clicks the rightmost button labeled 30, the solid-state image sensor 112 of the imaging unit 110 is rotated by 30° clockwise (in the same direction as with the rotation button 725).

While the foregoing description has been given using numerical values as an example, the numerical values are not limited to those mentioned above. Qualitative expressions such as large, intermediate, and small may be used instead of the numerical values. Displaying illustrations that visually show directions can help the user's intuitive operations, in which case numerical values do not need to be displayed.

The end button 642 is a button for ending the priority drive mode. If the end button 642 is selected, the processing of steps S406 to S408 of FIG. 6 is performed, and the driving positions and the display are restored to those in the browsing mode of FIGS. 7A and 7B.

As described above, when an object is detected, the operation GUIs are displayed with only the imaging unit 110 of the object-detecting camera selected. This enables the user to immediately operate the target imaging unit 110 upon object detection with improved operability.

### Display Image

In the priority drive mode, as illustrated in FIG. 9B, the display sizes of the images 501 to 504 may be changed. In the priority drive mode, the user makes operations while viewing the image 501 of the object-detecting camera. The images 502, 503, and 504 are therefore displayed in a smaller size to make a space where the image 501 can be displayed larger. Operation-specific GUIs may be displayed in the vacant space. Displaying the image 501 and GUIs for the user to operate improves the operability.

The operation-specific GUIs such as the operation panels 621 and 631 may be omitted. In such a case, an alternative mechanism for operating the driving units is provided. For example, the pan driving unit 114 and the tilt driving unit 116 may be operated by dragging or tapping the image 501. In such a case, only the image 501 of the object-detecting camera is made operable. For example, only the image 501 is displayed, and a GUI is displayed on the image 501 as an OSD.

Next, a supplementary description of the imaging unit selection panel 611 will be given. In transitioning to the priority drive mode, the object-detecting camera is desirably selected on the imaging unit selection panel 611. However, the imaging unit selection panel 611 may be configured so that another imaging unit can be selected after the transition. The imaging unit selection panel 611 does not necessarily need to be displayed upon transition.

The CPU 180 can select the imaging unit based on the user's operation on the imaging unit selection panel 611. The CPU 180 then controls to display on the display unit 203 a GUI operation area 601 capable of changing the imaging region of the imaging unit selected by the user's operation among the plurality of imaging units.

The imaging unit selection panel 611 desirably displays the positional relationship of the imaging units 110, 120, 130, and 140 illustrated in FIG. 9A in an easy-to-understand manner. If the pan driving unit 114 of the imaging unit 110 is driven, the position of the imaging unit selection button 711 on the imaging unit selection panel 611 is also moved to match the position of the imaging unit 110. The CPU 180 controls the display on the display unit 203 so that the positions of the plurality of imaging units 110, 120, 130, and 140 on the circumference 102 is displayed like the imaging unit selection panel 611. Since the user can thus recognize the positional relationship between the imaging units 110, 120, 130, and 140, the driving range is clarified for improved operability.

### Driving End

FIG. 9A illustrates the driving end 106 of the pan driving units. The imaging units 110, 120, 130, and 140 are unable to be operated beyond the driving end 106 of the pan driving units. The driving end 106 may be a physical hardware driving end, or a software driving end beyond which the user is unable to issue instructions. If there is such a driving end 106, a display indicating the not-drivable position is desirably provided like the driving end 715 on the imaging unit selectin panel 611. This enables the user to know the drivable range and improves operability.

### Operation GUI (Slider Bars)

While FIG. 9B illustrates an operation example with the operation panels 621 and 631, the operation panels 621 and 631 may be replaced with slider bars, or otherwise modified or changed.

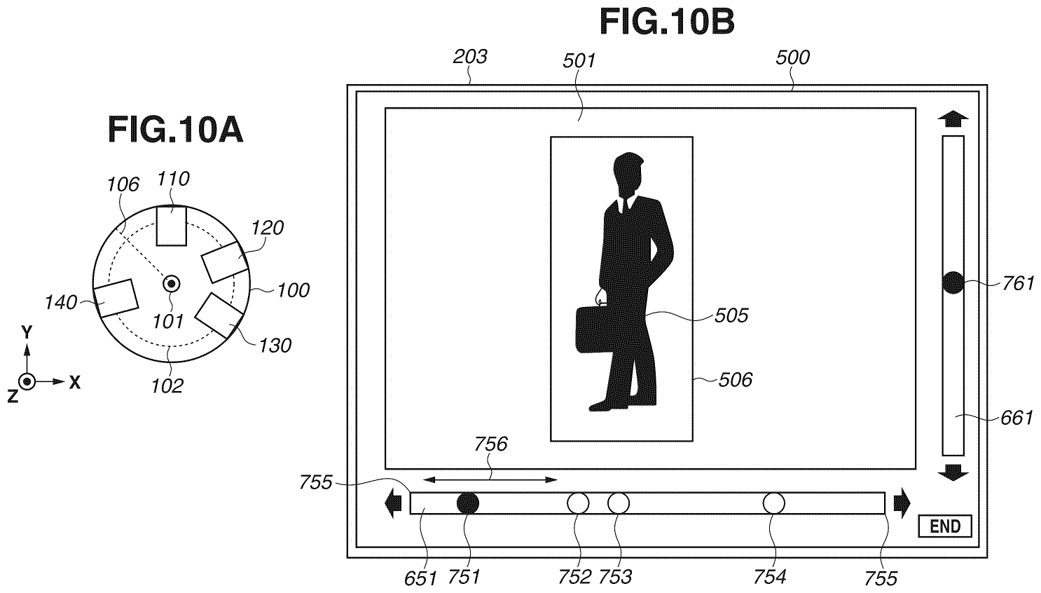

An example of the slider bars will be described with reference to FIGS. 10A and 10B. FIGS. 10A and 10B are diagrams illustrating the example of the slider bars according to the first exemplary embodiment. Like FIGS. 9A and 9B, FIGS. 10A and 10B illustrate a display example in the priority drive mode.

A pan operation bar 651 in FIG. 10B is a GUI for operating the pan driving unit 114.

Since the imaging units 110, 120, 130, and 140 are located on the same circumference 102 and the drivable range varies depending on the positional relationship of the imaging units 110, 120, 130, and 140, the positions of all the imaging units 110, 120, 130, and 140 are desirably displayed in an easy-to-understand manner.

In FIG. 9B, the positional relationship of the imaging units 110, 120, 130, and 140 is displayed on the imaging unit selection panel 611. In FIG. 10B, the positional relationship of the imaging units 110, 120, 130, and 140 is displayed on the pan operation bar 651 that is a slider bar.

In FIG. 10B, a pan button 751 corresponds to the imaging unit 110. A pan button 752 corresponds to the imaging unit 120. A pan button 753 corresponds to the imaging unit 130. A pan button 754 corresponds to the imaging unit 140.

FIG. 10B illustrates a state where the object-detecting camera (pan button 751) is selected, as with the imaging unit selection panel 611 of FIG. 9B. Here, the user can drive the pan driving unit 114 of the selected imaging unit 110 by clicking on a desired position on the slider bar. Note that the range where pan driving can be performed from the current position is confined to not exceed the driving end 106 or the positions of the other imaging units.

In FIG. 10B, the position corresponding to the driving end 106 in FIG. 10A is represented by a driving boundary 755. The slider bar is generated so that the driving boundary 755 falls on the ends of the slider bar. The range where the pan button 751 of the imaging unit 110 can be moved is between the driving boundary 755 corresponding to the driving end 106 and the pan button 752 corresponding to the imaging unit 120. The range is indicated by an arrow 756.

As illustrated in FIG. 10B, displaying the range where the imaging unit 110 (pan button 751) can be operated can improve the user's operability.

A tilt operation bar 661 indicates the range where the tilt driving unit 116 of the imaging unit 110 can move. A tilt button 761 is displayed at the current position of the tilt driving unit 116. Unlike the pan driving unit 114, the tilt driving unit 116 does not interfere with the other imaging units in position. The tilt operation bar 661 therefore displays only the tilt button 761 corresponding to the selected imaging unit 110.

An example where desired positions on the slider bars are specified has been described as an operation method using the slider bars. However, the pan button 751 may be dragged. The operation panels of FIG. 9B may be used as well.

While the slider bars have been described by using the pan driving unit 114 and the tilt driving unit 116 as an example, the other driving units are also applicable as with the tilt driving unit 116.

### Imaging Units and Driving Units

While the configuration with the four imaging units 110, 120, 130, and 140 has been described, the present exemplary embodiment is applicable to an imaging apparatus 100 including two or more independently drivable imaging units.

While an example of the imaging units 110, 120, 130, and 140 where the pan driving units 114, 124, 134, and 144 are arranged on the same circumference 102 has been described, such an arrangement is not necessarily needed. The present exemplary embodiment is applicable to an imaging apparatus 100 that includes a plurality of imaging units, and includes driving units for the respective imaging units.

### Highlighting

The CPU 180 can make the image for the user to pay attention to more visible by highlighting the image 501 of the object-detecting camera. Highlighting refers to displaying the image 501 of FIGS. 8B and 9B in a color frame 506, or displaying the image 501 in a larger size like FIG. 9B.

### Electronic Zoom

In the foregoing description, the zoom driving unit 115 is described to be driven in changing the zoom magnification. However, the present exemplary embodiment is also applicable to electronic zooming using digital processing.

### Supplementary Description of Method for Transitioning Between Browsing Mode and Priority Drive Mode

The same operation GUIs may be displayed in the browsing mode and the priority drive mode. Upon transitioning to the priority drive mode, the imaging unit 110 of the object-detecting camera is selected, and the other imaging units 120, 130, and 140 are deselected. This enables the user to operate the imaging unit 110 without the trouble of selecting it.

### Method for Transitioning to Priority Drive Mode

In FIG. 8B, the priority drive button 507 is described to be displayed when an object is detected. However, when an object is detected, the browsing mode may forcefully transition to the priority drive mode of FIG. 9B. This improves the user's operability since the object-detecting camera can be immediately operated. Such a method for transitioning to the priority drive mode without the user's selection will be referred to as forced transition.

If the priority drive button 507 is displayed to enable the user's selection as in FIG. 8B, unnecessary transitions to the priority drive mode can be avoided. This enables operation according to the user's intention. Such a method for transitioning to the priority drive mode based on the user's selection will be referred to as discretionary transition.

### Method for Transitioning to Priority Drive Mode Depending on Type of Object Detection

The CPU 180 may determine which transition method to perform, forced transition or discretionary transition, depending on the type of object detection. As a method for transitioning to the priority drive mode, three GUIs “1. no transition”, “2. discretionary transition”, and “3. forced transition” may be provided so that the user can set the transition method with respect to each type of object detection.

A description will be given using three types of object detection (moving object detection, human detection, and abnormal behavior detection). Moving object detection, human detection, and abnormal behavior detection are performed in this order. More specifically, an object detected as a moving object by moving object detection is subjected to human detection to determine whether the object is a human. If the object is determined to be a human, i.e., a human is detected, the target is subjected to abnormal behavior detection to detect whether the target is behaving abnormally. The detection frequency of moving object detection is therefore the highest, and the detection frequency of abnormal behavior detection is the lowest.

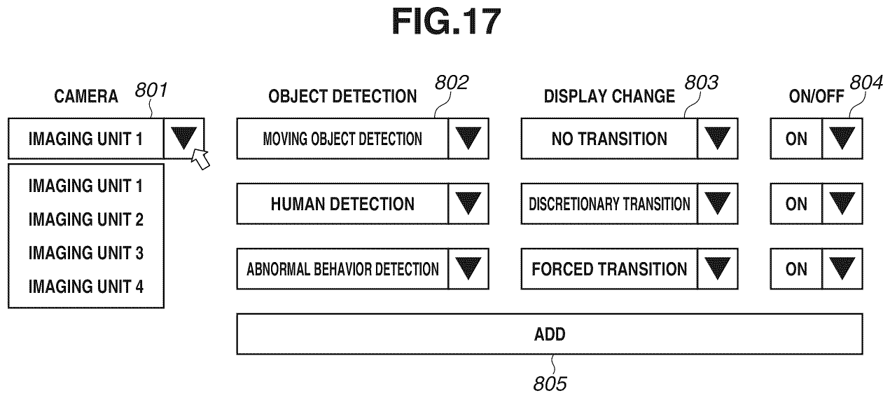

An example of the transition method GUIs will be described with reference to FIG. 17. FIG. 17 is a diagram illustrating an example of the transition method GUIs. While FIG. 17 illustrates only the transition method GUI section, the GUIs are displayed on a part of the display image 500 like other GUIs.

The CPU 180 displays an imaging unit selection panel 801, an object detection selection panel 802, a transition method panel 803, an on/off setting panel 804, and an add button 805 as the transition method GUIs.

The imaging unit selection panel 801 is used to select the imaging unit to configure settings of. The object detection selection panel 802 is used to set object detection methods. The detection area can be set by operating a not-illustrated image GUI. The transition method panel 803 is used to set the transition methods when an object is detected. The transition method panel 803 is desirably capable of configuring settings with respect to each imaging unit and each object. The on/off setting panel 804 is used to select whether to detect an object. The add button 805 can be used to add object detection settings.

Now, a case where the user performs object detection with focus on whether suspicious individuals enter a specific area will be described. The following description will be given on the assumption that the user wishes to ignore moving bodies entered if the moving bodies are animals, and conversely wishes to operate an imaging unit so that attention can immediately focus on a moving body if the moving body is a human behaving abnormally.

A case where the types of object detection include moving object detection, human detection, and abnormal behavior detection as will be described. The respect object detection methods will be described below.

The risk level to the user increases in order of moving object detection, human detection, and abnormal behavior detection. The user therefore sets “1. no transition” for moving object detection of which the risk level is the lowest, “2. discretionary transition” for human detection, and “3. forced transition” for abnormal behavior detection.

This enables the user to operate the object-detecting camera the more immediately the higher the risk level is (the more of interest the object is). If the risk level is low, the browsing mode is maintained so that the user can pay attention to the display of the imaging units other than the object-detecting camera as well.

As illustrated in FIG. 17, the CPU 180 can configure the settings “1. no transition”, “2. discretionary transition”, and “3. forced transition” for each imaging unit and for each type of object detection, based on the user's operations.

In the case of the setting “2. discretionary transition”, the CPU 180 performs the processing of steps S401 to S408 of FIG. 6. In the case of the setting “3. forced transition”, after YES in step S401 in the flowchart of FIG. 6, the processing proceeds to step S405 regardless of the user's operation.

### Supplementary Description of Transition Methods

While the foregoing description has been given by using an example where the GUIs for setting the transition methods are displayed, the transition methods may be determined in advance for the respective types of object detection. For example, if the type of object detection is a first type, the CPU 180 performs the processing for “discretionary transition”. If the type of object detection is a second type, the CPU 180 performs the processing for “forced transition”.

The transition method may be determined based on the detection frequency of the object. If the detection frequency of the object is high, the transition method is set to “1. no transition”. If the detection frequency is intermediate, the transition method is set to “2. discretionary transition”. If the detection frequency is low, the transition method is set to “3. forced transition”. For example, if the detection frequency of the object is a first detection frequency, the CPU 180 performs the processing for “discretionary transition”. If the detection frequency of the object is a second detection frequency, the CPU 180 performs the processing for “forced transition”.

User operations after the transition to the priority drive mode may be learned using machine learning. The CPU 180 initially transitions to the priority drive mode upon object detection, so that the user can operate the object-detecting camera. If the object is one for which the user makes no operations (or the operation frequency is low), the CPU 180 reconfigures the transition to the priority drive mode to “1. no transition”. On the other hand, if the object is one for which the user makes operations (or the operation frequency is high), the CPU 180 reconfigures the transition to the priority drive mode to “3. forced transition”.

An example where the transition methods are set for the respective types of object detection has been described. However, setting conditions such as detection areas may differ even for the same type of objects. In such a case, the transition methods are desirably settable object by object instead of type by type.

The types of object detection and the detection methods will now be described in a supplementary manner. The types of object detection and the detection methods described below are not restrictive, and can be modified or changed.

### Moving Object Detection

If there is a luminance difference between frames, the object detection unit 161 can detect a moving body. If a moving body is detected, the object detection unit 161 detects the moving body as a moving object.

### Human Detection

The object detection unit 161 may calculate edges/feature points of the detection area of the moving body and performs attribute identification for identifying the moving body from the shape of the edges/feature points (such as a head shape). For example, if a moving object is determined to be a human by the attribute identification, the object detection unit 161 detects the moving object as a human.

### Abnormal Behavior Detection

If a human is detected, the object detection unit 161 may make a determination (behavior identification) based on the person's behavior. For example, if the detected human is looking around or running, the object detection unit 161 determines the behavior as suspicious, and detect the behavior as an abnormal behavior.

### Other Detections

Several examples of the types of object detection will be described. The object detection unit 161 can calculate the edges of an image area (object) specified by the user and detect the movement of the object to detect removal or abandonment of an object based on changes in the edges.

Such a detection is also applicable to vehicles and animals irrespective of humans.

The object detection unit 161 can perform specific personal detection for determining whether the human is a specific person registered in advance, based on the feature points of the captured person's face. For example, the object detection unit 161 compares the shapes of the eyes, nose, and mouth of the captured person and their sizes relative to the face with personal image data registered in advance, and calculates a degree of matching. If the degree of matching is high, the object detection unit 161 determines that the person is a specific individual.

Moreover, the object detection unit 161 can calculate the edges/feature points of the detection region of the moving body, and perform attribute identification to estimate age and gender based on the shape of the edges/feature points.

### Detection of Motion Vector

The object detection unit 161 can perform edge detection on a moving body detected by moving body detection, and determine differences between frames to calculate the moving direction (motion vector) of the moving body.

The CPU 180 may set the transition method based on the motion vector, i.e., depending on the speed of the moving body. If the moving speed of the moving body is high, immediate operations may be desirable, and the transition method is set to “3. forced transition”. By contrast, if the moving speed of the moving body is low, the user can take time to switch operations, and the transition method is set to “1. no transition”.

While the transition method is described to be set to either “1. no transition” or “3. forced transition”, this is not restrictive. The transition method may be freely set between “1. no transition” and “2. discretionary transition”, between “2. discretionary transition” and “3. forced transition”, or to change stepwise between “1. no transition”, “2. discretionary transition”, and “3. forced transition”.

While an example where the imaging units have a driving mechanism on the common circumference 102 as their pan driving units has been described, the imaging units may have a common driving mechanism other than the pan driving units.

A second exemplary embodiment will be described. In the first exemplary embodiment, a method for performing the image processing by the image processing unit 151 of the imaging apparatus 100 has been described. The second exemplary embodiment deals with a case where the client apparatus 200 takes charge of at least some of the functions of the image processing unit 151. For example, object detection may be performed by the client apparatus 200. The image processing for displaying OSDs may be performed by the client apparatus 200.

Differences of the second exemplary embodiment from the first exemplary embodiment will now be described.

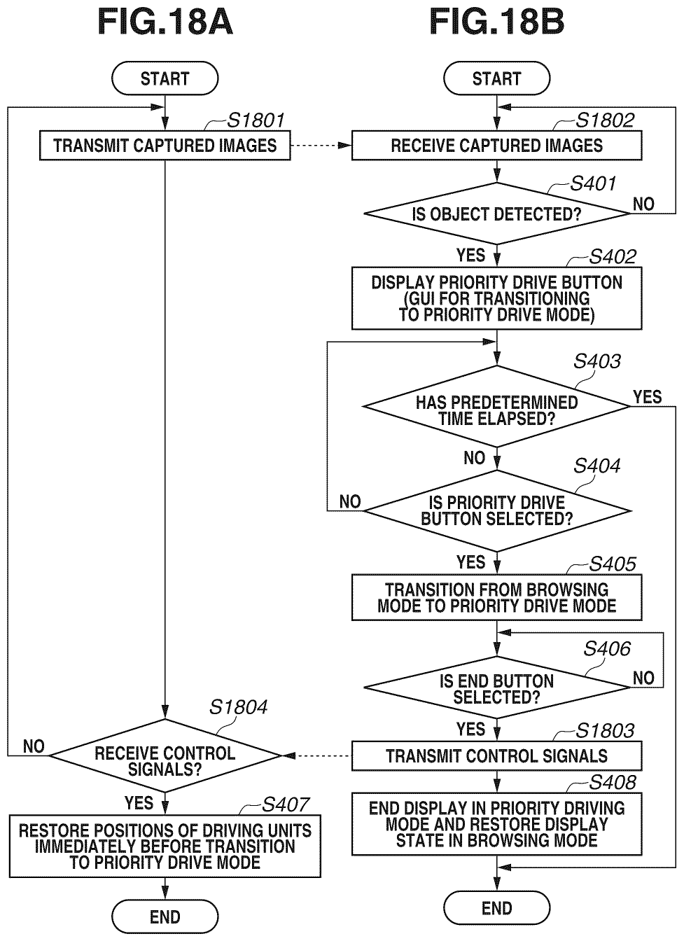

FIG. 18A is a flowchart illustrating a control method of the imaging apparatus 100 according to the second exemplary embodiment. FIG. 18B is a flowchart illustrating a control method of the client apparatus 200 according to the second exemplary embodiment. The flowchart of FIG. 18A is implemented by the CPU 180 of the imaging apparatus 100 executing a program loaded into the RAM 181. The flowchart of FIG. 18B is implemented by the CPU 280 of the client apparatus 200 executing a program loaded into the RAM 281. The client apparatus 200 is an example of a control apparatus. The plurality of imaging units 110, 120, 130, and 140 is disposed outside the client apparatus 200.

In step S1801, the CPU 180 of the imaging apparatus 100 transmits images captured by the imaging units 110, 120, 130, and 140 to the client apparatus 200 via the network I/F 183 in units of frames of the captured images. The CPU 180 may transmit information about the pan angles, tilt angles, zoom magnifications, rotation angles, and focus positions of the imaging units 110, 120, 130, and 140 to the client apparatus 200 via the network I/F 183 in units of frames of the captured images as appropriate.

In step S1802, the CPU 280 of the client apparatus 200 receives the captured images of the imaging units 110, 120, 130, and 140 from the imaging apparatus 100 via the network I/F 283 in units of frames of the captured images. The CPU 280 may receive the information about the pan angles, tilt angles, zoom magnifications, rotation angles, and focus positions of the imaging units 110, 120, 130, and 140 from the imaging apparatus 100 via the network I/F 283 in units of frames of the captured images.

In step S401, the CPU 280, from images captured by the plurality of imaging units 110, 120, 130, and 140, determine whether the object is detected. For example, as illustrated in FIG. 7B, the CPU 280 detects the moving body 505 in the image 501 captured by the imaging unit 110 as an object. If no object is detected (NO in step S401), the processing returns to step S1802. If an object is detected (YES in step S401), the processing proceeds to step S402.

In step S402, the CPU 280 controls to display on the display unit 203 the images 501 to 504 in the browsing mode and the frame 506 of the moving body 505 as illustrated in FIG. 8B. The CPU 280 further superimposes the priority drive button 507 on the object-detected image 501 on the display unit 203 as illustrated in FIG. 8B. The priority drive button 507 is a GUI for selecting whether to transition to the priority drive mode.

In step S403, the CPU 280 determines whether a predetermined time has elapsed since the processing of step S402. If the predetermined time has not elapsed (NO in step S403), the processing proceeds to step S404. If the predetermined time has elapsed (YES in step S403), the flowchart of FIG. 18B ends.

In step S404, the CPU 280 determines whether the priority drive button 507 is selected (clicked, tapped, or otherwise operated) by the user. If the priority drive button 507 is selected (YES in step S404), the processing proceeds to step S405. If the priority drive button 507 is not selected (NO in step S404), the processing returns to step S403.

In step S405, the CPU 280 transitions from the browsing mode to the priority drive mode.

The CPU 280 then controls to display on the display unit 203 the GUI operation area 601 capable of changing the imaging region of only the imaging unit 110 that is the object-detecting camera among the plurality of imaging units 110, 120, 130, and 140 as illustrated in FIG. 9B. The operation area 601 includes the imaging unit selection panel 611, the operation panel 621, the operation panel 631, and the end button 642.

The CPU 280 also controls to display on the display unit 203 the images 501 to 504 captured by the plurality of imaging unis 110, 120, 130, and 140 as illustrated in FIG. 9B.

The CPU 280 records the positions of the driving units of the object-detecting camera immediately before the transition to the priority drive mode in the recording unit 205. The GUIs capable of changing the imaging region of the object-detecting camera are displayed with the imaging region of only the object-detecting camera changeable.

The CPU 280 further instructs the imaging apparatus 100 to change the imaging region of the imaging unit 110 capturing the image 501 where the object is detected, based on operations on the operation panel 621 or 631 of FIG. 9B.

In step S406, the CPU 280 determines whether the end button 642 of FIG. 9B is selected. If the end button 642 is selected (YES in step S406), the processing proceeds to step S1803 to cancel the priority drive mode. If the end button 642 is not selected (NO in step S406), the processing returns to step S406. The user can operate the object-detecting detecting camera using the GUIs in the priority drive mode of FIG. 9B until the end button 642 is selected.

After the processing of step S405, the processing may proceed to step S1803 after a lapse of a predetermined time even if the end button 642 is not selected in step S406.

In step S1803, the CPU 280 reads the positions of the driving units of the object-detecting camera immediately before the transition to the priority drive mode from the recording unit 205. The CPU 280 then transmits control signals related to the pan angles, tilt angles, zoom magnifications, rotation angles, and focus positions of the imaging units 110, 120, 130, and 140 to the imaging apparatus 100 via the network I/F 283 so that the positions of the driving units of the object-detecting camera immediately before the transition to the priority drive mode are restored.

In FIG. 9B, the CPU 280 can also change the imaging region of an imaging unit selected by the user among the plurality of imaging units. In such a case, if the end button 642 is selected (YES in step S406), then in step S1803, the CPU 280 issues instructions to restore the imaging regions of all the plurality of imaging units to those immediately before the display of the operation area 601.

In step S1804, the CPU 180 of the imaging apparatus 100 determines whether the control signals related to the pan angles, tilt angles, zoom magnifications, rotation angles, and focus positions of the imaging units 110, 120, 130, and 140 are received from the client apparatus 200 via the network I/F 183. If the control signals are not received (NO in step S1804), the processing returns to step S1801.

If the control signals are received (YES in step S1804), the processing proceeds to step S407.

In step S407, the CPU 180 controls the pan angles, tilt angles, zoom magnifications, rotation angles, and focus positions of the imaging units 110, 120, 130, and 140 based on the received control signals. Specifically, the CPU 180 control those factors to restore the positions of the driving units of the object-detecting camera immediately before the transition to the priority drive mode.

In step S408, the CPU 280 of the client apparatus 200 controls the display on the display unit 203 to end the display in the priority drive mode of FIG. 9B and restore the display state in the browsing mode of FIG. 8B.

A third exemplary embodiment will be described. The first exemplary embodiment has dealt with the display example in the priority drive mode. In the first exemplary embodiment, as illustrated in FIG. 10B, the driving boundary 755 of the pan driving units can be limited depending on the position of other imaging units (adjacent imaging units). If the user wishes to operate the pan driving unit 114 of the object- detecting camera beyond the limited driving boundary 755, the pan driving units of imaging units (adjacent imaging units) other than the object-detecting camera are therefore desirably operated to extend the driving range of the object-detecting camera.

However, if the user operates imaging units other than the object-detecting camera, the operation is complicated since the user operates more than one imaging unit. The third exemplary embodiment describes a method for extending the driving range of the object-detecting camera through control of the imaging units other than the object-detecting camera in the priority drive mode without the user operating more than one imaging unit.

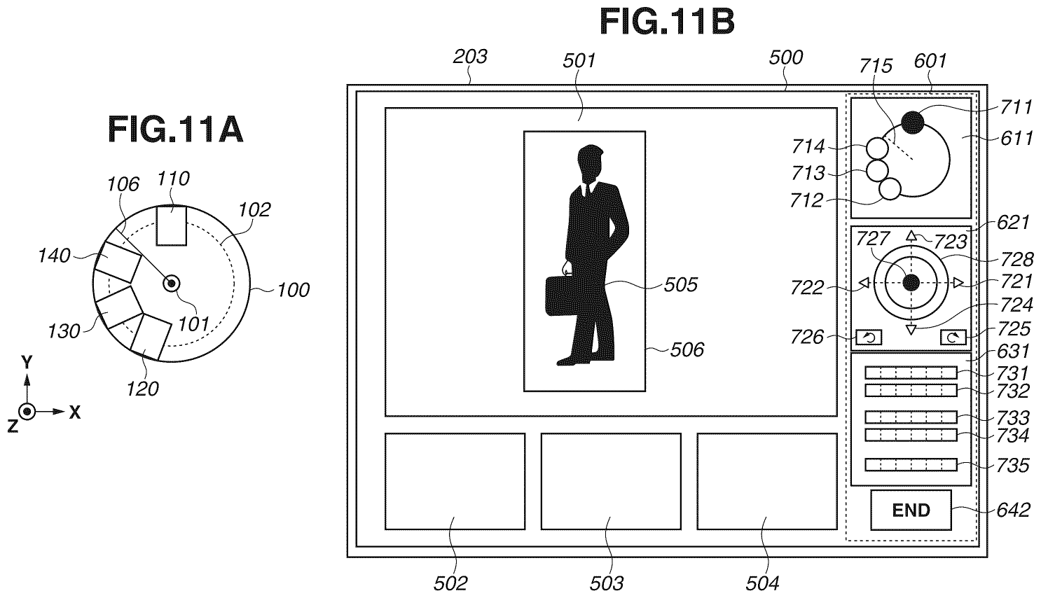

The control of the imaging units other than the object-detecting camera according to the third exemplary embodiment will be described with reference to FIGS. 11A to 13B. FIGS. 11A to 13B illustrate the control of the pan driving units of the imaging units other than the object-detecting camera.

FIGS. 11A and 11B are diagrams illustrating an example where there is a driving end 106 and the imaging units other than the object-detecting camera are withdrawn according to the third exemplary embodiment. FIGS. 11A and 11B illustrate how the imaging apparatus 100 withdraws the imaging units other than the object-detecting camera in the priority drive mode of FIGS. 9A and 9B. FIGS. 11A and 11B illustrate a state where the imaging units other than the object-detecting camera are panned to extend the range where the object-detecting camera can be driven.

The pan driving units, tilt driving units, and rotation driving units of the imaging units 120, 130, and 140 can be driven by selecting the imaging unit selection buttons 712, 713, and 714, respectively.

In FIG. 11B, like FIG. 9B, the imaging unit selection button 711 is selected upon transitioning to the priority drive mode. Here, the control unit 152 controls the pan driving units 124, 134, and 144 of the imaging units 120, 130, and 140 other than the object-detecting camera to positions where the driving range of the imaging unit 110 that is the object-detecting camera is extended.

To extend the driving range of the object-detecting camera, the pan driving units 124, 134, and 144 are driven in a direction such that the imaging units 120, 130, and 140 other than the object-detecting camera get away from the object-detecting camera.

FIG. 11A illustrates the case where there is a driving end 106. The driving end 106 is located counterclockwise from the imaging unit 110, whereby the driving range is limited. It can be seen that the counterclockwise driving range is not limited by the other imaging units 120, 130, and 140.

By contrast, the imaging unit 120 is located clockwise from the imaging unit 110, whereby the driving range is limited. The driving range of the imaging unit 110 can thus be extended by driving the pan driving unit 124 of the imaging unit 120 clockwise. Since the imaging unit 120 driven clockwise can interfere with the imaging unit 130, the imaging unit 130 is also desirably driven clockwise like the imaging unit 120. The imaging unit 140 is also desirably driven clockwise.

In FIG. 11A, the driving range of the imaging unit 110 can be maximized by driving the imaging unit 140 up to the driving end 106 and also driving the imaging units 130 and 120 as close to the driving end 106 as possible.

As described above, the movement of the imaging unit 110 that is the object-detecting camera in a first direction on the circumference 102 is restricted by the driving end 106. In such a case, the CPU 180 issues instructions so that the imaging unit 120, which is adjacent to the imaging unit 110 capturing the object-detected image 501 in a second direction opposite to the first direction on the circumference 102, moves in the second direction on the circumference 102.

If, for example, the object-detecting camera is the imaging unit 120, the pan driving unit 114 of the imaging unit 110 is driven counterclockwise up to the driving end 106, and the imaging units 140 and 130 are driven clockwise toward the driving end 106.

The CPU 180 thus issues instructions so that the imaging unit 110, which is adjacent to the imaging unit 120 capturing the object-detected image 502 in the first direction on the circumference 102, moves in the first direction on the circumference 102. The first direction is the counterclockwise direction, for example.

The CPU 180 also issues instructions so that the imaging unit 130, which is adjacent to the imaging unit 120 capturing the object-detected image 502 in the second direction opposite to the first direction on the circumference 102, moves in the second direction on the circumference 102. The second direction is the clockwise direction, for example.

In such a manner, the driving range of the object-detecting camera (imaging unit 120) can be maximized through driving based on the positional relationship between the object-detecting camera and the other imaging units.

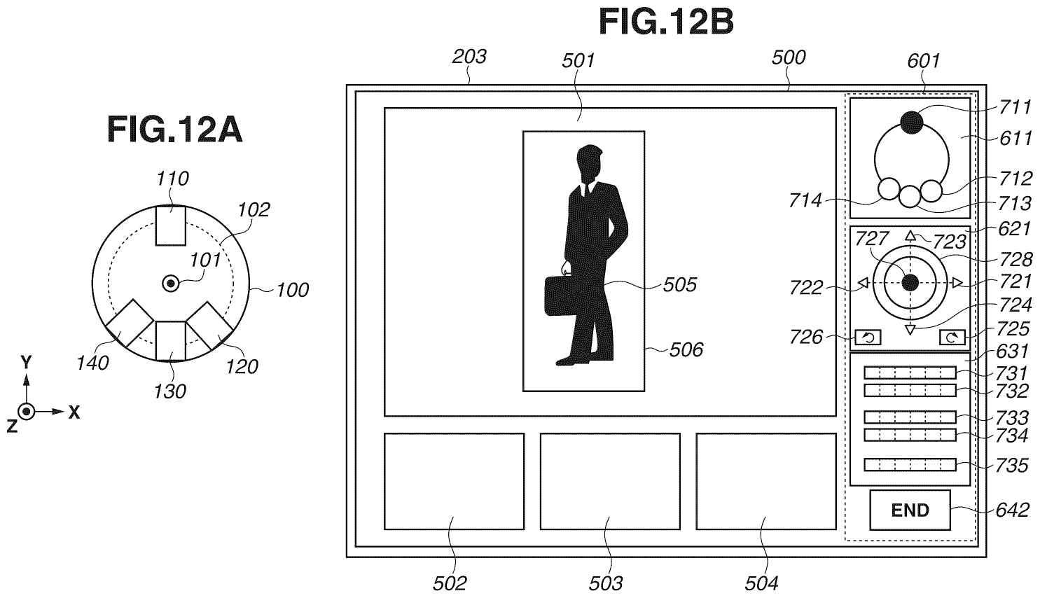

FIGS. 12A and 12B are diagrams illustrating an example where there is no driving end 106 and the imaging units other than the object-detecting camera are withdrawn. In the absence of the driving end 106, the imaging units 120, 130, and 140 are driven toward a position opposite the imaging unit 110 (position where the relative pan angle is 180°). This can maximize the range where the imaging unit 110 that is the object-detecting camera can be driven.

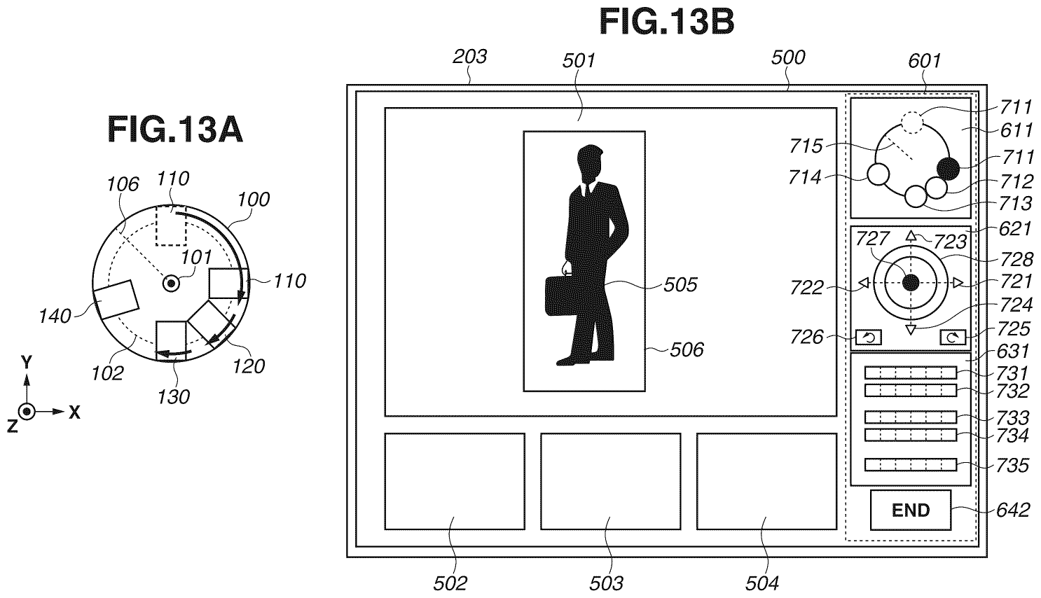

In FIGS. 11A to 12B, examples of driving the other imaging units 120, 130, and 140 upon transitioning to the priority drive mode have been described. Now, a method for controlling the imaging units 120, 130, and 140 other than the object-detecting camera based on the user's operation of the object-detecting camera during the priority drive mode will be described with reference to FIGS. 13A and 13B.

FIGS. 13A and 13B are diagrams illustrating a control example of the imaging units 120, 130, and 140 other than the object-detecting camera based on the user's operation of the object-detecting camera during the priority drive mode according to the third exemplary embodiment. FIGS. 13A and 13B illustrate the control of the imaging units 120, 130, and 140 other than the object-detecting camera in a case where the user operates the pan driving unit 114 of the imaging unit 110 that is the object-detecting camera and the other imaging units 120, 130, and 140 are located in the driving direction.

Compared to FIGS. 9A and 9B, FIGS. 13A and 13B illustrate a state where the user is long-pressing the pan button 721 corresponding to the imaging unit 110 that is the object-detecting camera.

Continuing driving the pan driving unit 114 of the imaging unit 110 clockwise causes an interference with the imaging unit 120, and the driving range is restricted there.

As illustrated in FIGS. 13A and 13B, the driving range of the imaging unit 110 can be extended by moving the other imaging unit 120 in the same direction (clockwise) based on the operation of the pan driving unit 114 of the object-detecting camera.

Continuing driving the imaging unit 120 clockwise causes an interference with the imaging unit 130. The imaging unit 130 is therefore desirably driven clockwise as well. The same applies to the imaging unit 140.

Suppose, as mentioned above, that the imaging unit 110 capturing the object-detected image 501 is instructed to move in a first direction on the circumference 102 by operating the operation panel 621 or 631. The first direction is the clockwise direction, for example. In such a case, the CPU 180 issues instructions so that the imaging unit 110 capturing the object-detected image 501 moves in the first direction and the imaging unit 120 adjacent to the imaging unit 110 capturing the object-detected image 501 in the first direction moves in the first direction.

When the user operates the object-detecting camera, the driving range of the object-detecting camera can thereby be extended without the user controlling the other imaging unit 120, 130, and 140.

Driving the imaging unit 120 at a speed equivalent to or higher than that of the imaging unit 110 can further reduce hindrance to the operation of the imaging unit 110. Moreover, the pan driving of the imaging unit 120 may be started not when the interference with the imaging unit 110 occurs but when an instruction to drive the imaging unit 110 toward the imaging unit 120 is given or when a difference between the pan angles of the imaging units 120 and 110 falls to or below a threshold. This can further reduce hindrance to the operation of the imaging unit 110.

If an instruction to drive the imaging unit 110 counterclockwise is given after the imaging unit 120 is driven clockwise, the imaging unit 120 may be driven counterclockwise with the imaging unit 110.

While the imaging unit 120 has been described, the same applies to imaging units 130 and 140.

If the end button 642 is selected, the positions of all the imaging units 110, 120, 130, and 140 are desirably restored to the state before the transition to the priority drive mode. This enables the user to start operation at the state before the object detection.

In FIGS. 13A and 13B, the imaging unit 110 and the imaging unit selection button 711 in the dotted lines are illustrated to clarify the description of the position before driving (the same position as in FIGS. 9A and 9B).

The automatic control of the imaging units 120, 130, and 140 other then the object-detecting camera thus extends the driving range of the object-detecting camera and improves the user's operability.

In the third exemplary embodiment, the method for driving the imaging units 120, 130, and 140 other than the object-detecting camera has been described. However, the imaging units 120, 130, and 140 other than the object-detecting camera can capture images in directions unexpected by the user.

It is therefore desirable for the user to be able to specify and fix the position(s) of an imaging unit or units that the user does not want to change the imaging region(s) of. The CPU 180 can set whether to fix the imaging ranges (for example, pan driving units) of the plurality of respective imaging units 110, 120, 130, or 140 independently of each other.

If, for example, the user fixes the position of the imaging unit 120 in FIGS. 13A, the driving range of the pan driving unit 114 is the same as in FIG. 9A even if the imaging unit 110 enters the priority drive mode as an object-detecting camera.

The user settings (fixing instructions) to fix the position(s) can be configured upon initial installation of the imaging apparatus 100. The imaging unit selection panel 611 of FIG. 9B may be an GUI having that function.

In the third exemplary embodiment, the client apparatus 200 may perform the processing like the second exemplary embodiment.

A fourth exemplary embodiment will be described. The third exemplary embodiment has dealt with the method for controlling the imaging units other than the object-detecting camera, whereas the imaging units other than the object-detecting camera can capture images in directions unexpected by the user. In view of this, in the fourth exemplary embodiment, a method for switching the selection of the imaging unit depending on the limitation of the driving range of the object-detecting camera will be described.

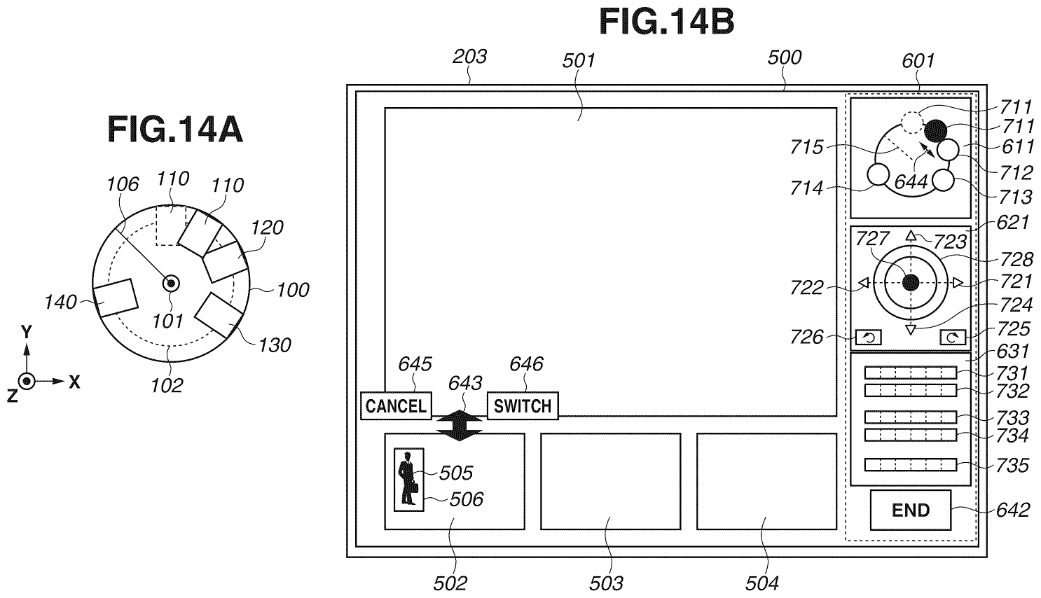

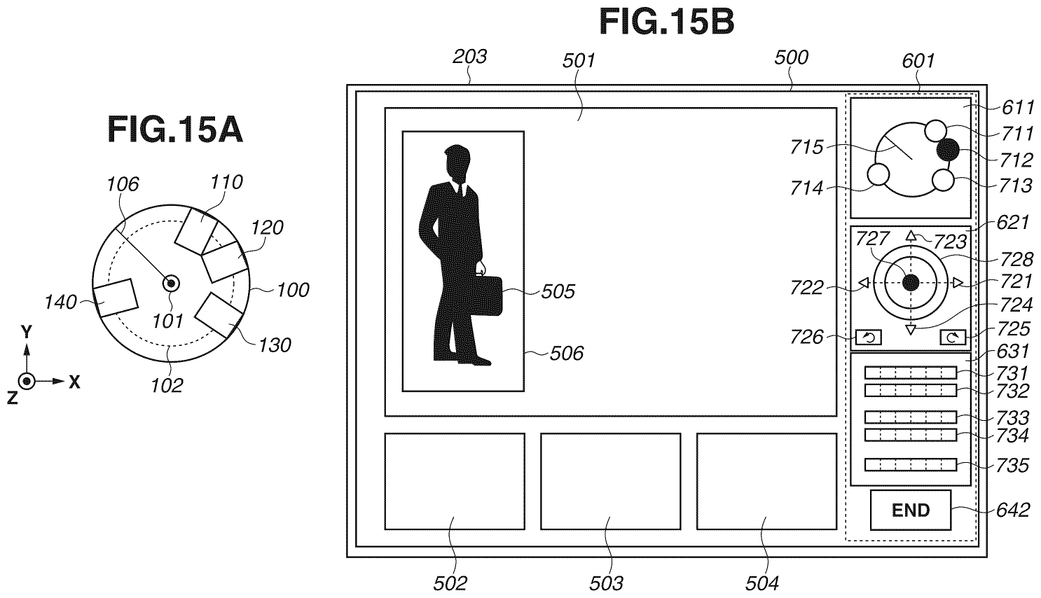

In FIGS. 14A to 15B, switching control on the selection of the imaging unit that is the object-detecting camera will be described. Referring to FIGS. 14A to 15B, a method for switching the selection of the imaging unit that is the object-detecting camera will be described.

FIGS. 14A and 14B are diagrams illustrating a display example where the selection of the imaging unit that is the object-detecting camera is switched according to the fourth exemplary embodiment. Compared to FIGS. 9A and 9B, FIGS. 14A and 14B illustrate a state where the moving body 505 moves clockwise from the imaging unit 110 and the user operates the pan button 721 based on the movement of the moving body 505.

Here, the pan driving unit 114 can be driven until the imaging unit 110 is about to interfere with the imaging unit 120. However, the imaging unit 110 is unable to be moved clockwise any further due to the presence of the imaging unit 120. FIGS. 14A and 14B illustrate a state where the moving body 505 continues moving, goes off the imaging region of the imaging unit 110, and enters the image 502 of the imaging region of the imaging unit 120.

In the present exemplary embodiment, when the imaging unit 110 is driven to the position just short of interfering with the imaging unit 120 (or the user continues to operate the pan button 721 despite the position where the imaging unit 110 is unable to be driven any further), the selection of the imaging unit is switched.

Here, the user is desirably notified of the switching of the selection of the imaging unit before the selection of the imaging unit is switched. FIG. 14B illustrates a display example thereof. In FIG. 14B, display indicating the switching is provided within the display image 500.

An arrow 643 indicates the image to be switched from (image 501) and the image to be switched to (image 502) to demonstrate that the object-detecting camera is being switched. Similarly, an arrow 644 in the imaging unit selection panel 611 indicates the imaging unit selection buttons 711 and 712 to be switched.

The CPU 180 also controls to display a cancel button 645 so that the user can cancel the switching if unwilling to switch. If the cancel button 645 is selected by the user, the imaging units are not switched.

If a predetermined time has elapsed without the cancel button 645 being selected, the selection of the imaging unit is switched. If the user wishes to switch immediately, the user can select a switch button 646 to immediately switch the selection of the imaging unit.

A display example after the switching of the selection of the imaging unit will be described with reference to FIGS. 15A and 15B. FIGS. 15A and 15B are diagrams illustrating the display example after the selection of the imaging unit is switched according to the fourth exemplary embodiment. In FIGS. 15A and 15B, the imaging unit 110 (imaging unit selection button 711) selected as the object-detecting camera before is deselected and the imaging unit 120 (imaging unit selection button 712) is selected as a new object-detecting camera operable.

With the imaging unit selectin button 712 selected, the pan driving unit 124, the tilt driving unit 126, and the rotation driving unit 127 of the imaging unit 120 become operable.

As illustrated in FIG. 15B, the images 501 and 502 may be switched in position on the display image 500.

The user can thereby extend the imaging range of the object-detecting camera.

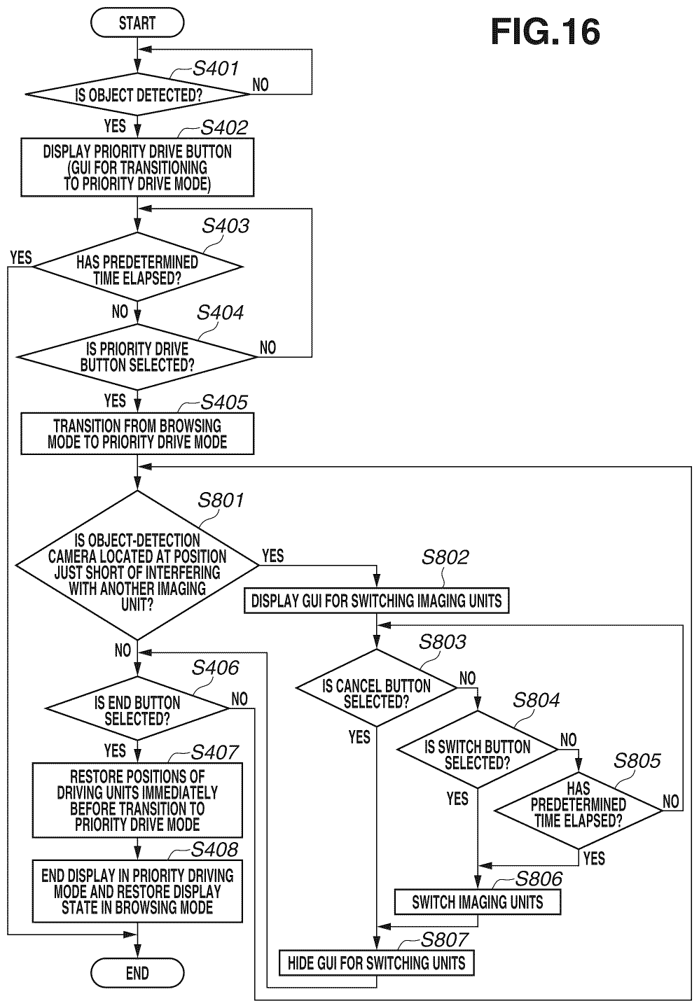

The switching of the imaging units illustrated in FIGS. 14A to 15B will be described with reference to the flowchart of FIG. 16. FIG. 16 is a flowchart illustrating the control method of the imaging apparatus 100 according to the fourth exemplary embodiment. This flowchart is implemented by the CPU 180 of the imaging apparatus 100 executing a program loaded into the RAM 181. The flowchart of FIG. 16 is the flowchart of FIG. 6 to which steps S801, S802, S803, S804, S805, S806, and S807 are added. Steps S801, S802, S803, S804, S805, S806, and S807 are all steps in the priority drive mode. Descriptions redundant between FIGS. 16 and 6 will be omitted.

The imaging apparatus 100 initially performs the processing of steps S401 to S405 as in FIG. 6.

In step S801, the CPU 180 then determines whether the imaging unit 110 that is the object-detecting camera is located at a position just short of interfering with another imaging unit 120 as illustrated in FIG. 14A. If the object-detecting camera is not located at the position just short of interfering (NO in step S801), the processing proceeds to step S406 since the object-detecting camera can be driven and the selection of the imaging unit does not need to be switched. If the object-detecting camera is located at the position just short of interfering (YES in step S801), the processing proceeds to step S802.

The processing may also proceed to step S802 if the movement of the imaging unit 110 that is the object-detecting camera on the circumference 102 is restricted.

In step S802, the CPU 180 controls to display on the display unit 203 the switch button 646 and the cancel button 645 that are a GUI for switching the imaging units as illustrated in FIG. 14 for user notification.

In step S803, the CPU 180 determines whether the cancel button 645 is selected as illustrated in FIG. 14B. If the cancel button 645 is not selected (NO in step S803), the processing proceeds to step S804. If the cancel button 645 is selected (YES in step S803), the processing proceeds to step S807 to hide the switching display without switching the selection of the imaging unit.

In step S804, the CPU 180 determines whether the switch button 646 is selected by user operation as illustrated in FIG. 14B. If the switch button 646 is not selected (NO in step S804), the processing proceeds to step S805. If the switch button 646 is selected (YES in step S804), the processing proceeds to step S806 to switch the selection of the imaging unit.

In step S805, the CPU 180 determines whether a predetermined time has elapsed since the processing of step S802. If the predetermined time has elapsed (YES in step S805), the processing proceeds to step S806 to switch the selection of the imaging unit. If the predetermined time has not elapsed (NO in step S806), the processing returns to step S803 to wait for the user's selection.

In step S806, the CPU 180 controls to display on the display unit 203 the display image 500 where the selection of the imaging unit is switched as illustrated in FIG. 15B.

For example, if the movement of the imaging unit 110 that is the object-detecting camera in the first direction on the circumference 102 is restricted, the CPU 180 controls to display an operation area 601 capable of changing the imaging region of the imaging unit 120 adjacent to the imaging unit 110 that is the object-detecting camera in the first direction on the circumference 102.

If the movement of the imaging unit 110 that is the object-detecting camera in the first direction on the circumference 102 is restricted, the CPU 180 also controls the display so that the image of the imaging unit 110 that is the object-detecting camera and the image of the imaging unit 120 adjacent in the first direction switch their display positions. The processing then proceeds to step S807.

In step S807, the CPU 180 controls 203 to hide on the display unit the GUI for switching the selection of the imaging unit, displayed in step S802. Specifically, the CPU 180 controls the display so that the arrows 643 and 644, the cancel button 645, and the switch button 646 are not displayed on the display unit 203.

In such a manner, if the object-detecting camera interferes with another imaging unit and the driving range is limited, the switching of the selection of the imaging unit (imaging unit interfering with the object-detecting camera) is controlled. This extends the driving range of the object-detecting camera and improves the user's operability.

### Supplementary Description

In FIG. 14B, the moving body 505 is described to move from the image 501 to the image 502. However, the selection of the imaging unit can be switched even when the capturing position of the moving body 505 remains unchanged.

If the moving body 505 has moved from the image 501 to the image 502, the object is detected by the imaging unit 120. The selection of the imaging unit may therefore be switched with the imaging unit 120 capturing the moving body 505 as the object-detecting camera. The imaging unit 120 can thereby be selected without the user switching the selection of the imaging unit.

The selection of the imaging unit is described to be switched when the imaging unit 110 is located at a position just short of interfering with the imaging unit 120 (or the user continues to operate the pan button 721 despite the position where the imaging unit 110 is unable to be driven any further). However, this is not restrictive. Examples of the condition to switch the selection of the imaging unit include when there is another imaging unit near the object-detecting camera (the position of the pan driving unit is within a threshold), and when the operated pan driving unit of the object-detecting camera interferes with another imaging unit.

In FIG. 14B, the selection of the imaging unit is described to be immediately switched by the user selecting the switch button 646. However, other buttons may be used instead. For example, if the user continues to press the pan button 721 even in situations where the imaging unit 110 is unable to move clockwise due to the imaging unit 120, the CPU 180 makes the same determination as when the switch button 646 is selected. This enables the user to capture an image of the imaging region to be operated.

In FIG. 14B, the switch button 646 and the cancel button 645 are described to be displayed at the same time. However, this is not restrictive. The switch button 646 may be displayed alone, and if the switch button 646 is not selected for a predetermined time, the switching may be cancelled. Alternatively, the cancel button 645 may be displayed alone, and if the cancel button 645 is not selected for a predetermined time, the switching may be performed. The switching may be forced without displaying the switch button 646 or the cancel button 645.

The method for switching from the browsing mode to the priority drive mode using the priority drive button 507 illustrated in FIG. 8B of the first exemplary embodiment can also be similarly modified. A cancel button may be displayed along with the priority drive button 507. Either button may be displayed alone. The priority drive mode may be forced without displaying the buttons. Like the fourth exemplary embodiment, the switching may be performed or cancelled if the displayed button is not selected for a predetermined time.

In the step S805 of FIG. 16, the processing is described to proceed to step S806 to switch the selection of the imaging unit if the predetermined time has elapsed. However, the flowchart may be modified so that the processing proceeds to step S807 without switching.

The imaging conditions of the imaging unit to be switched other than the object-detecting camera are desirably matched with those of the object-detecting camera. The imaging conditions refer to the positions of the tilt driving unit, the rotation driving unit, the zoom driving unit, and the focus driving unit. The exposure, gain, shutter speed, and white balance are also desirably matched. The matching timing is when the switch button 646 of FIG. 14B is displayed or when the switch button 646 of FIG. 14B is selected.

As described above, according to the first to fourth exemplary embodiments, the imaging system 190 includes the plurality of imaging units 110, 120, 130, and 140, and can improve the operability in changing the imaging regions of the imaging units when an object is detected.

### Other Exemplary embodiments

The present exemplary embodiment can also be implemented by processing for supplying a program for implementing one or more functions of the foregoing exemplary embodiments to a system or an apparatus via a network or a storage medium, and reading and executing the program by one or more processors of a computer of the system or apparatus. A circuit for performing one or more of the functions (for example, application-specific integrated circuit [ASIC]) may be used for implementation.

While the exemplary embodiments of the present disclosure have been described, the present disclosure is not limited to these exemplary embodiments, and various modifications and changes can be made without departing from the gist thereof.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-011067, filed Jan. 29, 2024, which is hereby incorporated by reference herein in its entirety.

What is claimed is:

1. A control apparatus comprising:
one or more memories storing instructions; and
one or more processors executing the instructions to:
acquire a detection result of an object detected from images acquired by a plurality of respective imaging units configured to move independently on the same circumference; and
in a case where the object is determined to be detected based on the detection result, control to display a first graphical user interface on a display unit, the first graphical user interface being configured to change an imaging region of an imaging unit acquiring an image where the object is detected among the plurality of imaging units.

2. The control apparatus according to claim 1, wherein the one or more processors execute the instructions to issue an instruction to change the imaging region of the imaging unit acquiring the image where the object is detected, based on an operation on the first graphical user interface.

3. The control apparatus according to claim 1, wherein the one or more processors execute the instructions to, in a case where movement of the imaging unit acquiring the image where the object is detected in a first direction on the circumference is restricted, issue an instruction to move an imaging unit in a second direction opposite to the first direction on the circumference, the imaging unit being adjacent to the imaging unit acquiring the image where the object is detected in the second direction on the circumference.

4. The control apparatus according to claim 1, wherein the one or more processors execute the instructions to issue an instruction to move an imaging unit in a first direction on the circumference, the imaging unit being adjacent to the imaging unit acquiring the image where the object is detected in the first direction on the circumference.

5. The control apparatus according to claim 4, wherein the one or more processors execute the instructions to issue an instruction to move an imaging unit in a second direction opposite to the first direction on the circumference, the imaging unit being adjacent to the imaging unit acquiring the image where the object is detected in the second direction on the circumference.

6. The control apparatus according to claim 1, wherein the one or more processors execute the instructions to, in a case where an instruction to move the imaging unit acquiring the image where the object is detected in a first direction on the circumference is issued by an operation on the first graphical user interface, issue an instruction to move the imaging unit acquiring the image where the object is detected in the first direction and move an imaging unit in the first direction, the imaging unit being adjacent to the imaging unit acquiring the image where the object is detected in the first direction.

7. The control apparatus according to claim 1, wherein whether to fix imaging ranges of the plurality of imaging units is settable for the respective imaging units.

8. The control apparatus according to claim 1, wherein the one or more processors execute the instructions to control display indicating positions of the plurality of imaging units on the circumference on the display unit.

9. The control apparatus according to claim 1, wherein the one or more processors execute the instructions to:
control to display a second graphical user interface on the display unit, the second graphical user interface being configured to switch display; and
control to display the first graphical user interface on the display unit based on an operation on the second graphical user interface.

10. The control apparatus according to claim 9, wherein the one or more processors execute the instructions to:
in a first case, control to display the second graphical user interface, and control to display the first graphical user interface on the display based on the operation on the second graphical user interface; and
in a second case, control to display the first graphical user interface on the display unit regardless of a user's operation.

11. The control apparatus according to claim 10,
wherein the first case is where a first setting is made,
wherein the second case is where a second setting is made, and
wherein the first setting or the second setting is made for each type of object detection depending on the user's operation.

12. The control apparatus according to claim 10,
wherein the first case is where a type of object detection is a first type, and
wherein the second case is where the type of object detection is a second type.

13. The control apparatus according to claim 10,
wherein the first case is where a detection frequency of the object is a first detection frequency, and
wherein the second case is where the detection frequency of the object is a second detection frequency.

14. The control apparatus according to claim 10,
wherein the object is a moving body,
wherein the first case is where a moving speed of the moving body is a first speed, and
wherein the second case is where the moving speed of the moving body is a second speed.

15. The control apparatus according to claim 1, wherein information about the imaging region includes at least one of a pan angle, a tilt angle, a zoom magnification, and a rotation angle.

16. The control apparatus according to claim 1, wherein the one or more processors execute the instructions to control to display a third graphical user interface on the display unit, the third graphical user interface being configured to change an imaging region of an imaging unit selected by a user's operation among the plurality of imaging units.

17. The control apparatus according to claim 1, wherein the one or more processors execute the instructions to, in a case where the first graphical user interface is instructed to end or after a lapse of a predetermined time since the display of the first graphical interface, issue an instruction to restore imaging regions of all the plurality of imaging units to those immediately before the display of the first graphical user interface.

18. The control apparatus according to claim 1, wherein the one or more processors execute the instructions to, in a case where movement of the imaging unit acquiring the image where the object is detected in a first direction on the circumference is restricted, control to display a fourth graphical user interface based on a user's operation or after a lapse of a predetermined time, the fourth graphical user interface being configured to change an imaging region of an imaging unit adjacent to the imaging unit acquiring the image where the object is detected in the first direction on the circumference.

19. The control apparatus according to claim 18, wherein in a case where the movement of the imaging unit acquiring the image where the object is detected in the first direction on the circumference is restricted, control to switch display positions of the image of the imaging unit acquiring the image where the object is detected and the image of the imaging unit adjacent in the first direction.

20. The control apparatus according to claim 1, wherein the plurality of imaging units is built in the control apparatus.

21. The control apparatus according to claim 1, wherein the plurality of imaging units is disposed outside the control apparatus.

22. The control apparatus according to claim 1, wherein the one or more processors execute the instructions to control to display the images acquired by the plurality of imaging units on the display unit.

23. A control method of a control apparatus, comprising:
acquiring a detection result of an object detected from images acquired by a plurality of respective imaging units; and
in a case where the object is determined to be detected based on the detection result, controlling to display a first graphical user interface on a display unit, the first graphical user interface being configured to change an imaging region of an imaging unit acquiring an image where the object is detected among the plurality of imaging units.

24. A non-transitory computer-readable storage medium storing a program for causing a computer to perform a control method for a control apparatus, the control method comprising:
acquiring a detection result of an object detected from images acquired by a plurality of respective imaging units; and
in a case where the object is determined to be detected based on the detection result, controlling to display a first graphical user interface on a display unit, the first graphical user interface being configured to change an imaging region of an imaging unit acquiring an image where the object is detected among the plurality of imaging units.
